(19) United States
(12) Patent Application Publication
(10) Pub. No.: US 2013/0246217 A1
(43) Pub. Date: Sep. 19, 2013

(54) METHOD, APPARATUS, AND COMPUTER PROGRAM PRODUCT FOR PROVIDING CONTRACT ANALYTICS

(71) Applicant: APTITUDE, LLC, Irving, TX (US)

(72) Inventors: Joel Walter Denton, Cedar Hill, TX (US); Troy Wayne Kirchenbauer, Hurst, TX (US); Russell Francis Lewis, Dallas, TX (US); John Walter Mallinckrodt, II, Dallas, TX (US); Patrick Robert Richer, Dallas, TX (US); Daniel Clark Sweeney, Southlake, TX (US); Scott Michael Willey, Lewisville, TX (US)

(73) Assignee: APTITUDE, LLC, Irving, TX (US)

(21) Appl. No.: 13/835,878

(22) Filed: Mar. 15, 2013

Related U.S. Application Data
(60) Provisional application No. 61/611,302, filed on Mar. 15, 2012.
(60) Provisional application No. 61/611,306, filed on Mar. 15, 2012.
(60) Provisional application No. 61/611,311, filed on Mar. 15, 2012.
(60) Provisional application No. 61/611,312, filed on Mar. 15, 2012.
(60) Provisional application No. 61/611,317, filed on Mar. 15, 2012.

(51) Int. Cl. G06Q 30/06

(52) U.S. Cl. CPC G06Q 30/0631
USPC 705/26.7

(57) ABSTRACT

Some examples provide systems, methods, apparatus, and computer program products for providing a market platform. The market platform may operate to inform buyers and suppliers, to allow buyers and suppliers to select products and contracting parameters to meet their needs, to allow buyers and suppliers to commit to supply agreements, and to enforce those supply agreements. The market platform may be further configured to capture data related to transactions performed by buyers and suppliers that use the market platform system to perform said transactions. This data may be utilized to generate a set of analytics to assist both buyers and suppliers with making informed decisions about their transactions. The market platform may identify correlations between buyer characteristics and product selections, to assist the buyer with selecting products that are generally appropriate for their particular characteristics and/or needs.

### CROSS-REFERENCE TO RELATED APPLICATIONS

This application claims the benefit of and priority to U.S. Provisional Application No. 61/611,302, filed Mar. 15, 2012, U.S. Provisional Application No. 61/611,306, filed Mar. 15, 2012, U.S. Provisional Application No. 61/611,311, filed Mar. 15, 2012, U.S. Provisional Application No. 61/611,312, filed Mar. 15, 2012, and U.S. Provisional Application No. 61/611,317, filed Mar. 15, 2012, each herein incorporated by reference in their entirety.

### TECHNOLOGICAL FIELD

Example embodiments of the present invention relate generally to computer-provided services and, more particularly, to systems, methods, apparatuses, and computer program products for providing contract analytics.

### BACKGROUND

Advances in information technology have revolutionized some product supply chains. So-called enterprise resource planning (ERP) and supply chain management systems provide users with the capability to link various elements of product/service supply chains by providing a single data repository of manufacturing, accounting, sales, and customer relationship management. However, these systems are typically only useful for supply chains with defined, predictable, product sourcing arrangements. For example, such systems may be optimized for scenarios in which a buyer contracts to buy a defined number of products, and the buyer receives a discount based on the volume of their order.

In some industries, buyers are unable to plan their supply needs in advance with any particular level of certainty. For example, healthcare organizations (HCOs) typically run through particular medical supplies as they receive patients that require those supplies. It can be difficult, if not impossible, to predict the volume of such supplies that will be needed, as that would also require accurate prediction of which patients will get sick, in what way, and when. Additionally, some functionally equivalent products may have equivalents supplied by multiple suppliers. For example, latex surgical gloves may be marketed by several different suppliers under different brand names, even though the product is interchangeable across suppliers. One way that HCOs and other buyers with highly variable product needs have addressed the unpredictability of sales volume and the interchangeability of the products is to receive market-share based pricing from suppliers. For example, while the buyer may not be able to guarantee a particular volume, they may be able to guarantee that they will purchase 80% of products within a particular group of products from a particular supplier. In exchange, the supplier may offer the buyer a particular discount as long as the buyer meets their commitment to buy 80% of the products within the particular group of products from that particular supplier. For the purposes of this application, the term “products” is intended to have broad meaning, including but not limited to tangible and intangible goods both within and outside of the healthcare domain. Examples of these products may include medical supplies and devices, physician preference items, pharmaceuticals, capital, services, and the like.

Although this contracting method may help to ensure fairer pricing for the buyer without the need to commit to a particular purchase volume, monitoring compliance for such market-share based pricing and contracts is difficult, as it is up to the supplier to enforce the pricing even though the supplier may not have enough data to ensure compliance (e.g., each supplier knows the number of products purchased by the buyer from the supplier, but not how many products, including functionally equivalent products within the category were purchased by the buyer across all suppliers). Buyers have little incentive to inform suppliers when the buyer fails to meet its market share purchase commitments (as this would often trigger a higher cost or other penalty), but there are no other parties who are in a better position to determine whether such commitments are being met. Since compliance is difficult, if not impossible, to enforce, suppliers must build the cost of non-compliance and potential non-compliance into their offered contract price, often resulting in the supplier not offering the most competitive price possible. Suppliers may also wish to offer their buyers alternative contracting models based on the particular needs of the buyer, but enforcement of such alternative contracting models is difficult, if not impossible, with the current state of the art.

Furthermore, buyers may have a difficult time determining which contract offers to accept from suppliers' responses to a request for pricing (RFP), as particular suppliers may offer disparate pricing within product categories. For example, a buyer may lower costs in aggregate by agreeing to a particular contract to obtain a larger discount on a first, high volume product, even if the contract requires a high price for a second, low volume product. Without the ability to compare aggregate costs across products in a category or across categories, the buyer might be inclined to accept an alternative contract that provides a lower price on the second, low volume product, but less or no discount on the first, high volume product. Suppliers may also provide different coverage across a given group of products, and it may be difficult to compare pricing responses received from different suppliers.

Additionally, buyers may purchase many different distinct products. For example, a given healthcare organization may purchase tens of thousands of distinct medical and surgical supply product types. These buyers may purchase these products from hundreds or thousands of sellers, each of whom may offer different but similar products to meet a particular need of the buyer (e.g., to fulfill a need defined in a particular product category). Buyers may choose to purchase particular products for different reasons, including but not limited to user preferences, product quality and efficacy, competitive pricing options, or the need to establish multiple supply sources. In many cases, buyers will purchase multiple functionally equivalent products from multiple sellers. However, it may not be readily apparent to the buyer which products will best meet their various needs. As such, buyers are often forced to make product and supply contract decisions with incomplete information.

Each product provided by a supplier may have particular attributes describing the characteristics of the product. These attributes may be defined by the product manufacturer or supplier. Additionally, the supplier may determine the format, content, and units of measure for these attributes for each product provided by the supplier. It may therefore be difficult to use these product attributes for comparison between products, as a supplier may provide product attributes in a format that does not easily translate to attributes of products provided by a different supplier. Additionally, each product may be associated with many different attributes. Some of these attributes may be relevant to determining alternative products (e.g., the size or material of the product), while other attributes may be less useful (e.g., the color or other aesthetic attributes of the product). There are currently no standard definitions or central authority for determining which product attributes are “essential” when determining cross-references for products or groups of products. Furthermore, products may be “one-way” cross-references. For example, a 10 cc syringe may be a valid cross-reference for a 5 cc syringe or a 3 cc syringe (as the 10 cc syringe can hold at least as much fluid as the 5 cc syringe or the 3 cc syringe), but a 5 cc syringe may not be a valid cross-reference for the 10 cc syringe (as the 5 cc syringe cannot perform all of the same tasks as the 10 cc syringe). The process of determining which products are appropriate cross-references for one another across suppliers is thus a subjective, time consuming, expensive, and laborious process.

Therefore, a need exists for a market platform that provides advanced analytics based on the behavior of contracting parties to improve the availability of information to parties entering into a transaction.

### SUMMARY

Some example embodiments provide systems, methods, apparatus, and computer program products for providing a market platform. The market platform may operate to inform buyers and suppliers, to allow buyers and suppliers to select products and contracting parameters to meet their needs, to allow buyers and suppliers to commit to supply agreements, and to monitor compliance with and enforce those supply agreements. These embodiments may provide such an integrated system by receiving buyer spend data, generating a request for pricing, receiving contract offers from one or more suppliers based on the spend data, allowing the buyer to select one or more of the contract offers, and monitoring spend data to inform and/or enforce compliance with the selected contract offer. The system may include dynamic pricing models, altering the price of the purchased products based on compliance with the selected contract offer. The system may also allow for various contracting models for managing the pricing of products or providing other financial benefits to buyers and/or suppliers based on the contractual terms agreed to by the buyer and supplier. These financial benefits may include price discounts, rebate payments, escrow refunds, insurance premiums or benefits, or any other type of financial benefit agreed to by the buyer and supplier. The system may also provide the buyer with a plurality of contracting options across plurality of suppliers, including determining an optimal contracting mix for the buyer based on one or more criteria, such as minimizing aggregate cost, minimizing the number of suppliers, minimizing product conversions maintaining relationships with one or more particular suppliers, or the like. In this manner, embodiments may provide a complete, closed-loop market ecosystem that benefits both buyers and suppliers.

The market platform may be further configured to capture data related to transactions performed by buyers and suppliers that use the market platform system to perform said transactions. For the purposes of this application, the term “transactions” should be understood to include any interaction between a user and the market platform that may indicate any sort of user preference or pattern of behavior for entering a purchase agreement for one or more products, selecting one or more products during a contracting process, selecting one or more contract parameters or contract preferences during a contracting process, or the like. For example, a selection of a particular product for a purchase planning operation would still be a transaction for the purpose of this document, even if the selection is not actually purchased. Similarly, the term “transaction” does not necessarily require entry into a contract or an actual purchase operation. As such, data gathering interactions with the system such as manual entry of contract preferences or selecting a degree of difficulty for a particular contract category may also be “transactions” in accordance with various embodiments. This data may be utilized to generate a set of analytics to assist both buyers and suppliers with making informed decisions about their transactions. For example, the market platform may assist buyers with identification of particular cross-references when establishing a purchase plan for the buyer by examining products that are frequently selected by other buyers. In some embodiments, the market platform may identify correlations between buyer characteristics and product selections, to assist the buyer with selecting products that are generally appropriate for their particular characteristics. In some embodiments, the market platform may further capture data related to the difficulty or complexity of contracting for particular products or groups of products. This complexity data may be used by buyers and suppliers to assist with allocation of resources during the contracting process and provide awareness of good opportunities to contract.

In some embodiments, the market platform may also operate to verify or calibrate user input provided for analytic purposes. For example, the market platform may receive subjective measures of different qualities from users, such as a user estimation of a degree of difficulty for a particular contract category. The market platform may be operable to adjust the weight accorded to a user input based on various factors, such as, in the case of contract difficulty, the number of contracts the user has entered or the relative objective degree of difficulty of those contracts. Similarly, with respect to other analytics, embodiments may utilize objective data gathered from transactions to adjust, weight, and/or calibrate data received from users.

Embodiments may include a method for providing contract analytics. The method may include capturing a set of transaction data. The transaction data may include a selection of at least one product selected from a plurality of products. The selection may be performed by a first buyer during a first transaction. The method may also include determining, using a processor, that an alternative product is a valid cross-reference for the at least one product using the transaction data, and providing an indicator during a subsequent transaction for the at least one product. The indication may indicate that the at least one alternative product is a valid cross-reference for the at least one product.

Embodiments may include an apparatus for providing contract analytics. The apparatus may include at least one processor configured to capture a set of transaction data. The transaction data may include a selection of at least one product selected from a plurality of products. The selection may be performed by a first buyer during a first transaction. The apparatus may also be configured to determine that an alternative product is a valid cross-reference for the at least one product using the transaction data, and to provide an indicator during a subsequent transaction for the at least one product. The indication may indicate that the at least one alternative product is a valid cross-reference for the at least one product.

Embodiments may include a computer readable storage medium comprising instructions that, when executed by a processor, configure the processor. The instructions may configure the processor to capture a set of transaction data. The transaction data may include a selection of at least one product selected from a plurality of products. The selection may be performed by a first buyer during a first transaction. The instructions may further configure the processor to determine that an alternative product is a valid cross-reference for the at least one product using the transaction data, and to provide an indicator during a subsequent transaction for the at least one product. The indicator may indicate that the at least one alternative product is a valid cross-reference for the at least one product.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the disclosure in any way. It will be appreciated that the scope of the disclosure encompasses many potential embodiments, some of which will be further described below, in addition to those here summarized.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 depicts a block diagram of an apparatus in accordance with some example embodiments;

FIG. 2 depicts a block diagram of a market platform in accordance with some example embodiments;

FIG. 3 depicts a signaling diagram depicting messaging among a buyer, a supplier, and a market platform in accordance with some example embodiments;

FIG. 4 depicts a screen capture of a buyer dashboard interface in accordance with some example embodiments;

FIG. 5 depicts a screen capture of a buyer request for pricing response status interface in accordance with some example embodiments;

FIG. 6 depicts a screen capture of a buyer request for pricing generation interface in accordance with some example embodiments;

FIG. 7 depicts a screen capture of a supplier dashboard interface in accordance with some example embodiments;

FIG. 8 depicts a screen capture of a supplier request for pricing status interface in accordance with some example embodiments;

FIG. 9 depicts a screen capture of a supplier request for pricing detail view interface in accordance with some example embodiments;

FIG. 10 depicts a screen capture of a supplier request for pricing response preview interface in accordance with some example embodiments;

FIG. 11 depicts a screen capture of a buyer request for pricing response review interface in accordance with some example embodiments;

FIG. 12 depicts a contract status interface in accordance with some example embodiments;

FIG. 13 depicts a flow diagram of an example method for implementing a market platform in accordance with some example embodiments;

FIG. 14 depicts a screen capture of a compliance monitoring interface in accordance with some example embodiments;

FIG. 15 depicts a block diagram of a purchase planning system in accordance with some example embodiments;

FIG. 16 depicts a screen capture of an interface for selecting suppliers for comparison in accordance with some example embodiments;

FIG. 17 depicts a screen capture of an interface for generating initial allocations for a purchase plan in accordance with some example embodiments;

FIG. 18 depicts a screen capture of an interface measuring market share achievement towards meeting a market share target goal for a purchase plan in accordance with some example embodiments;

FIG. 19 depicts a screen capture of an interface for modifying values associated with a purchase plan in accordance with some example embodiments;

FIG. 20 depicts a screen capture of an alternative allocation modification interface in accordance with some example embodiments;

FIG. 21 depicts a screen capture of an example purchase plan interface in accordance with some example embodiments;

FIG. 22 depicts a screen capture of a product selection interface in accordance with some example embodiments;

FIG. 23 depicts a flow diagram of an example method for generating a purchase plan in accordance with some example embodiments;

FIG. 24 depicts a flow diagram of an example method for capturing product selection analytics in accordance with some example embodiments;

FIG. 25 depicts a flow diagram of an example method for generating a contract opportunity map in accordance with some example embodiments;

FIG. 26 depicts an illustration of an example of a contract opportunity map in accordance with some example embodiments; and

FIG. 27 depicts an illustration of an example of detail view of a contract opportunity map in accordance with some example embodiments.

### DETAILED DESCRIPTION

Aspects of the disclosure include an integrated market platform. The market platform may provide buyers and suppliers with information about a particular market (e.g., healthcare, pharmaceuticals, construction, office supplies, etc.), allowing the buyers and suppliers to enter informed decisions regarding purchase and supply contracts. The market platform may further provide capabilities for optimization, selection, and management of these contracts. Contracts entered between buyers and suppliers may be monitored by the market platform to ensure compliance with the terms of the contracts. Example embodiments may include methods, systems, apparatuses, and computer program products for leveraging access to buyer spend data to implement a system that allows customers to select a purchase plan that most meets their needs, while also measuring and/or enforcing compliance with contract terms. Such a system benefits both buyer and suppliers, as buyers are offered multiple options to optimize their spending patterns, while suppliers are ensured contract compliance, allowing them to offer optimal pricing to buyers.

The market platform may provide for efficient pricing and management of responses to RFPs prepared by buyers. In this regard, the market platform may provide interfaces for establishing product prices based on various factors, such as product category, market share commitment of the buyer, contract type and duration, and the like. An interface may be provided that allows for efficient management of these different parameters to provide buyers with a variety of options to allow for efficient allocation of purchase agreements. These parameters may include both fixed parameters (e.g., contract duration) and variable parameters (e.g., buyer spend in a particular category). The market platform may include monitoring and adjustment based on both types of parameters, including applying dynamic adjustments based on variable parameters as these parameters change.

The market platform may also provide an interface for buyers to consider contract pricing proposals received from multiple suppliers, and to simulate the effects of different contract performance parameters on said pricing proposals. Although this process may be optional for generating contracts using the market platform, it may impart useful data to buyers to assist with the contracting process. The market platform may thus provide buyers with the ability to test the impact of various contracting scenarios on their planned spending. The market platform may also advantageously provide a flexible interface that allows buyers to select product allocations that are as aggressive (e.g., commitment levels that may be more difficult for the buyer to meet) or conservative (e.g., commitment levels the buyer may have an easier time in meeting) as the buyer desires. Additionally, buyers may adjust their planned spending to account for their own unique needs (e.g., a desire to maintain a relationship with a particular supplier, or to fulfill the needs of a particular practitioner who desires a certain make/model of a product).

For example, the buyer may receive a set of contract proposals from several suppliers, with each supplier offering different products and discount terms at certain contract performance levels (e.g., market share commitment, sales volume, etc.). The market platform may display an initial product allocation to the buyer based on the received contract pricing proposals. For example, the market platform may analyze a historical spending history of the buyer and identify which products and contract performance levels the buyer is currently attaining This initial product allocation may be presented to the buyer via an interface that allows the buyer to adjust contract performance levels (e.g., to adjust contract durations), to select alternative products (e.g., to select products from another seller, or to select a different product from the same seller), to allocate spending to particular products (e.g., 50% of the buyer's purchasing for a particular group of products will be allocated to product A, 20% to product B, and 30% to product C) or to otherwise adjust planned spending. As the buyer updates these values, they may be provided with dynamic updates to estimated discount levels and overall spending for the products that are being analyzed. The market platform may also provide the buyer with the ability to optimize their spending for certain optimization parameters based on the pricing proposals received. The market platform may thus assist the buyer with selecting a group of products for purchasing based on responses received from an RFP, and allocating the buyer's spending across the selected products. The result of this planning may be a purchase plan, which includes a specific set of selected products and spending allocations among the set of selected products.

The purchase plan may also include data indicating a target market share commitment for particular suppliers, where the target market share commitment is derived from the selected products and spending allocations. The buyer may be presented with the ability to modify these values manually, or to allow the market platform to optimize the selections based on various factors. For example, the buyer may elect to generate a purchase plan that represents a selection of products and spending allocations that optimize the buyer's overall costs among the pricing proposals received, the buyer may elect to generate a purchase plan that optimizes their discount level with a particular supplier, or the buyer may elect to generate a purchase plan that stays as close as possible to the buyer's current spending allocations. The market platform may also provide the buyer with the ability to modify the purchase plan generated by these optimizations, including “locking” data associated with certain suppliers or product allocations and optimizing for the remaining, “unlocked” suppliers or product allocations. In this manner, the market platform provides buyers with the ability to plan their purchases in order to have a high degree of certainty that contract performance goals can be met, while also allowing continued monitoring of buyer spending against a determined plan to allow the buyer to monitor how their purchasing matches up with the original planned purchases.

The market platform may further operate to identify product cross-references for use in generation of these purchase plans. For example, different suppliers may sell similar products, each with a model number associated with the respective supplier. The market platform may allow for suppliers to note which of their products are similar to their competitor's products, so that the buyer may be presented with the option to select one or more of the supplier's products instead of the competitor's product. The market platform may examine buyer spend history to identify these cross-references. For example, the market platform may identify to the buyer which products are currently purchased by the buyer, and any products which have been identified by competitors as valid cross-references to the products purchased by the buyer. During the purchase planning process, buyers may be presented with cross-references from competitors that responded to the RFP.

Product cross-references may also be identified by other methods. The market platform may have the ability to analyze buyer spend data or purchase plans from other buyers and to determine which products are frequently selected as cross-reference items by the other buyers. These cross-references may be presented to the buyer during the purchase planning process as “community” or “crowd-sourced” cross-references. For the purposes of this application, the terms “crowd-sourced” and “community” should generally be understood to refer to data identified through analysis of transactions monitored by the market platform. Products, settings, contract terms, and the like that are referred to as “crowd-sourced” or “community” may be understood to refer to terms that have been identified as generally preferred or desired by analysis of the data captured by the market platform. Various methods and processes may be employed to determine these community or crowd-sourced cross-references, as these different methods may optimize for different characteristics which are desirable by the community for different reasons. For example, crowd-sourced cross-references may be determined by identifying products that are chosen most frequently within a category when a user is presented with a selection of particular products, determined by identifying products that are the subject of a greatest amount of spend in a category, or various combinations of these and other factors. Additionally or alternatively, some cross-references may be determined by product ratings, by explicit selection by the buyer, or by any other method for identifying similar products both within the same supplier and across different suppliers.

The market platform may further provide for capture of data relating to transactions performed using the market platform, and generation of analytics from this data. Analytic data generated in this manner may be provided to buyers and suppliers to assist with, for example, identification of good contracting opportunities, and selection of appropriate cross-reference products. These analytics may be captured and provided in an aggregated and anonymous format, such that individual buyer and supplier data is obfuscated and anonymized. The analytics provided by the market platform may be captured in such a way that no proprietary information is exposed for individual users. For example, a given buyer or supplier may be able to view summary data for all organizations or all organizations similar to the given buyer or supplier, but not data relating to a specific buyer or supplier. In some embodiments, the market platform can control the level of granularity of data (e.g., data may be provided at an organization level or aggregated across all similar providers, depending upon how much data has been gathered), and the market platform may adjust this level of granularity as the market evolves. For example, by providing more and more data to users of the market platform, users may become increasingly comfortable with the concept of sharing analytic information with one another, such that over time data may be provided at increased granularity. Although data may be gathered based on user transactions, users may be provided with the ability to “opt out” of some or all data gathering operations. However, opting out of providing analytic data may also reduce the granularity or eliminate the user's ability to view analytic data using the market platform. As another example, in some embodiments “opting out” may remove any information associated with the particular user from data gathering operations, though data may still be gathered for aggregation and analysis as part of analyzing all transaction data (e.g., data related to particular buyer or supplier characteristics may be purged, but general purchasing data may still be gathered).

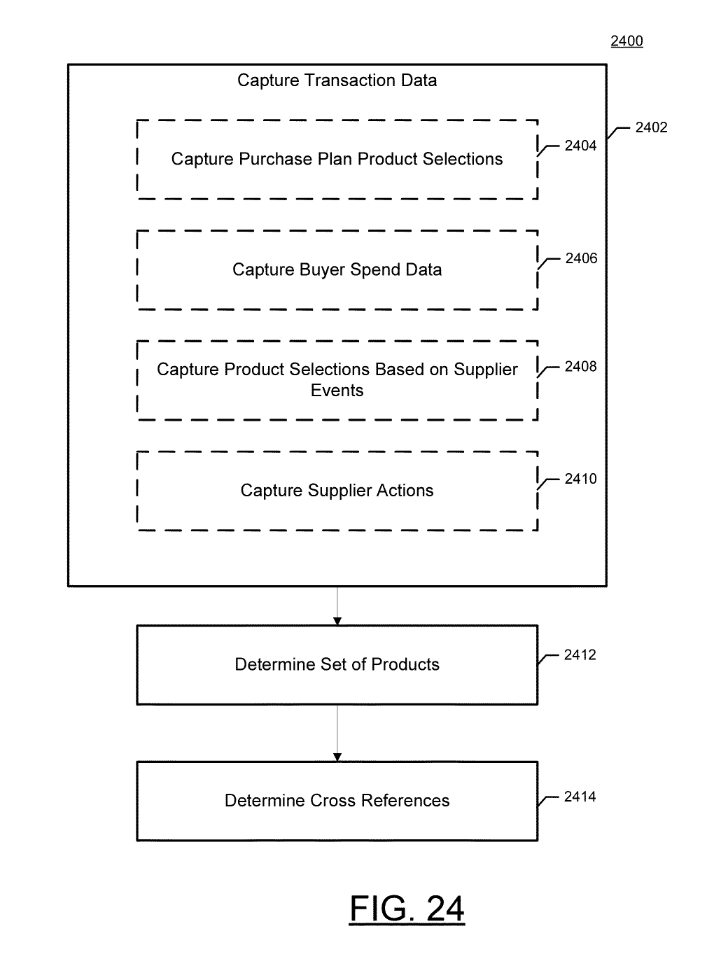

Market analytics may be derived from transactions entered into through the market platform and provided to buyers, suppliers, and other users in various formats. For example, buyers may be provided with information identifying some cross-references as derived from product selections and spending decisions made by other buyers and suppliers, and suppliers may be provided with information identifying certain contract parameters as preferable for a particular buyer or buyers sharing certain characteristics (e.g., buyers of a certain size or spend volume). An example method for using captured data to provide analytics is described further below with respect to FIG. 24.

The derived analytics may be useful to provide users with information about trends and decisions reflecting the state of the market. For example, users may be faced with a bewildering number of choices of products, contract opportunities, and the like. Various methods exist for determining optimal selections, but every user's needs may be different. The market platform may be in a particularly good position to observe and capture data related to user behavior at various points in the contracting and purchasing process. The market platform may capture this data over a large number users and transactions. The market platform may analyze this data and determine “crowd sourced” answers to subjective questions. For example, the market platform may identify a particular product as the “best” cross-reference to a specific product based on the product being the cross reference product that is chosen most frequently, or cross-references that reflect the greatest amount of spending during a purchase planning process. The market platform may use passive observation of participant behavior to derive this data. These “crowd sourced” determinations may provide a more accurate reflection of consensus answers in the market place than answers based on explicit participant voting or rating. Additionally, crowd-sourced solutions may be filtered based on the type of participant. For example, the crowd source cross-reference to a specific product could be filtered by the entire market or via buyer participants with roughly the same amount of spending volume, or by not-for-profit buyers vs. for-profit buyers. Over time, as more transaction data is gathered, analytics and other derived data may be updated and modified based on new transaction data. For example, product cross-references may change and update in response to buyers allocating their spending away from a previous product and towards a new product. In some embodiments, analytic data may be gathered for commercial purposes, such as to provide data derived from purchasing or spending data, such as cross-reference data or contracting preferences, to external parties. For example, a database of determined cross-references may be gathered and sold to a third party to provide analytic information to the third party for various purposes, such as marketing, product planning, product design, sales, or the like.

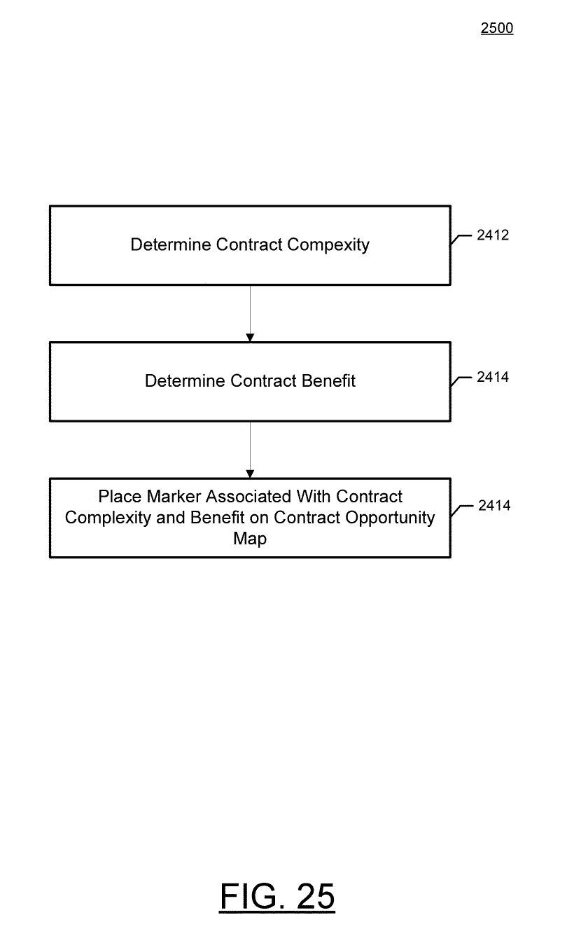

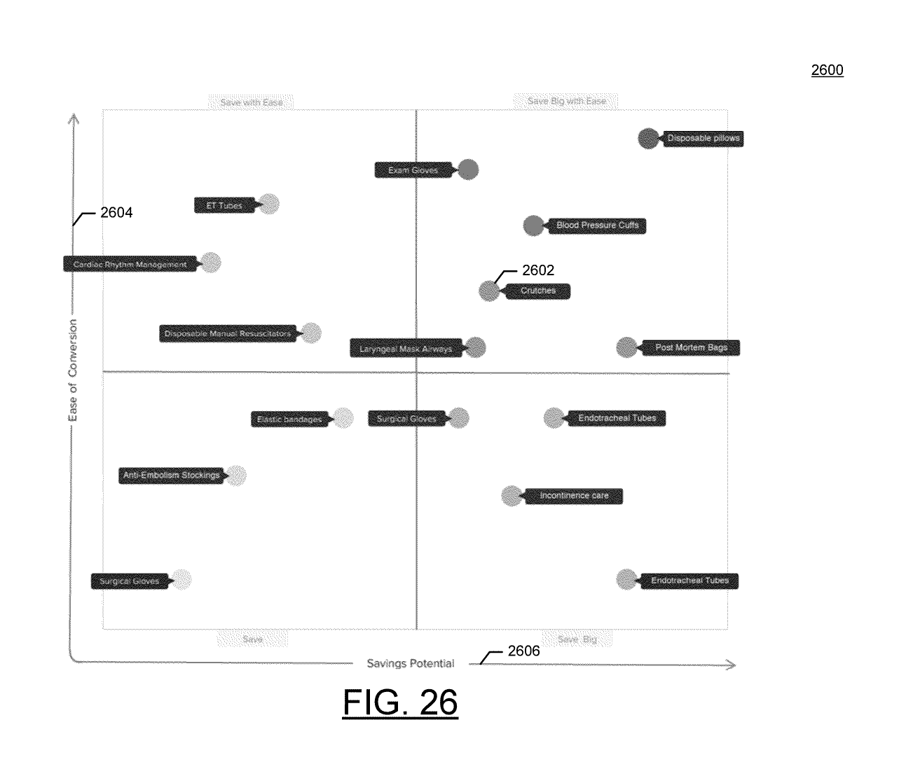

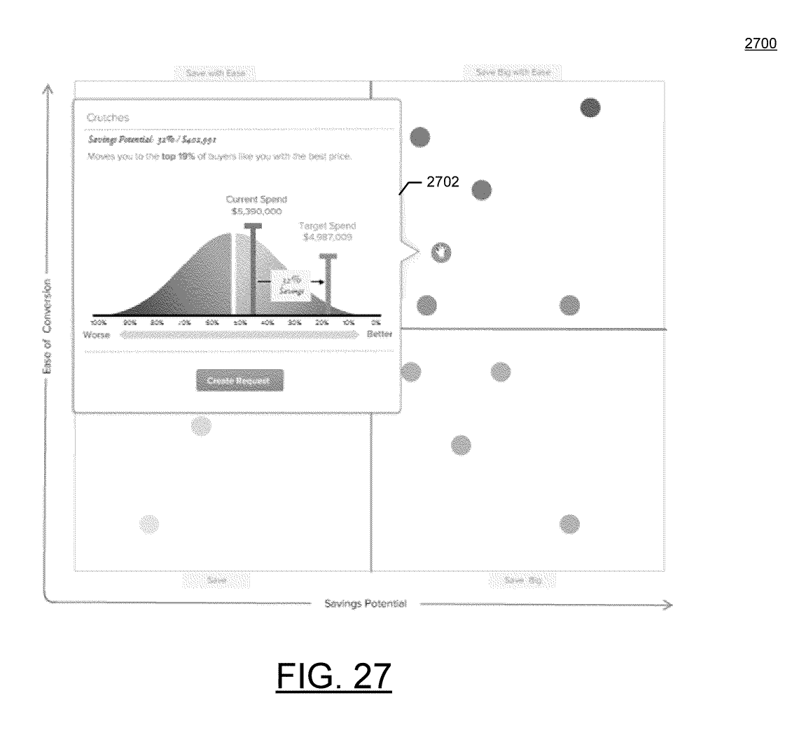

In some embodiments, the analytics may be used to generate a contract opportunity map. The contract opportunity map may provide a visual representation of the complexity of contracting for a particular product or set of products compared to the benefit likely to be realized by contracting for that particular product or set of products. An example method of generating such a contract opportunity map is described further below with respect to FIG. 25. Example illustrations of a contract opportunity map are described further below with respect to FIGS. 26 and 27.

Suppliers may utilize the market platform to generate price models for products. In the context of this application, the term “product” should be understood not only to encompass individual items provided by the supplier, but also sets of items (e.g., several items sold as a group or kit), services (e.g., labor or staffing needs), and various other tangible and intangible goods and services which may be procured according to a supply contract. Price models may be generated based on product price levels and discount terms established for different contract parameters by the supplier. For the purposes of this application, the term “contract parameters” refers to features of the contract that the supplier may wish to associate with discounts to incentivize the buyer to comply with particular parameters or engage in a particular contracted behavior. For example, the supplier may offer discounts based on contract parameters such as contract duration, market share commitment, buyer spend volume, or the like. The term “discount term” should be understood to relate to a particular discount level associated with performance according to a particular contract parameter. For example, a discount term of “5%” might be associated with a contract duration parameter of 24 months, or a discount term of “10%” might be associated with a market share parameter of “40% market share”. These discounts may, for example, take the form of a uniform discount applied to all products that are described within the pricing model (e.g., a discount percentage based on a spread between a minimum price and a maximum price), or a floor on an absolute discount (e.g., no more than a certain percentage off a list price). In circumstances where the discount represents a floor on an absolute discount, a single discount term may be used per pricing model (e.g., a maximum discount of 15%). These discount terms may be applied to a set of product price data to provide the buyer with a price response. The price response may provide the buyer with information sufficient to enable the buyer to observe the impact on product prices as the contract parameters are altered by the buyer.

The market platform may further provide an interface for management of compliance with commitments between the buyer and supplier. The ability to monitor buyer spend data allows the market platform to determine the market share the buyer is providing to the supplier for the particular product or product category that is the subject of a supply contract between the buyer and supplier. The market platform may report market share compliance to both the buyer and supplier, and measure and/or enforce contract provisions according to the market share commitment met by the buyer. The market platform may also allow for the buyer and supplier to agree to particular enforcement provisions, rewards, and penalties for individual contracts.

Embodiments of the invention may thus function to determine a value for a particular set or subset of contract offers for contract agreements between a buyer and a seller. In this context, the term “value” may be understood to be any quantitative or qualitative term that may be the subject of an optimization process. For example, a value may be a one or more of a financial term (e.g., a product cost or set of product costs), a quality term (e.g., a set of products that meet particular quality standards), an efficacy term (e.g., a set of products that have certain performance characteristics), a simplicity term (e.g., minimization of a change from a current set of suppliers), or any other value, quality, or characteristic.

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being captured, transmitted, received, displayed and/or stored in accordance with various example embodiments. Thus, use of any such terms should not be taken to limit the spirit and scope of the disclosure. Further, where a computing device is described herein to receive data from another computing device, it will be appreciated that the data may be received directly from the another computing device or may be received indirectly via one or more intermediary computing devices, such as, for example, one or more servers, relays, routers, and/or the like.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, an applications processor integrated circuit for an integrated circuit in a server, a network device, and/or other computing device.

As defined herein, a “computer-readable storage medium,” which refers to a non-transitory physical storage medium (e.g., volatile or non-volatile memory device), can be differentiated from a “computer-readable transmission medium,” which refers to a transitory electromagnetic signal.

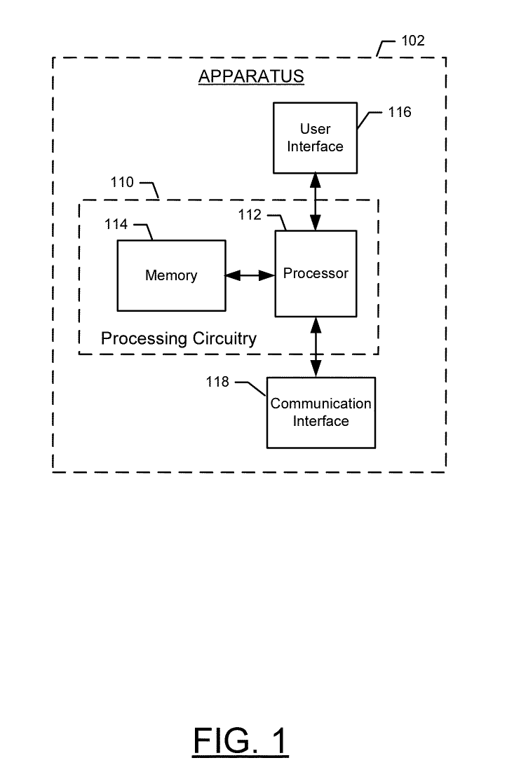

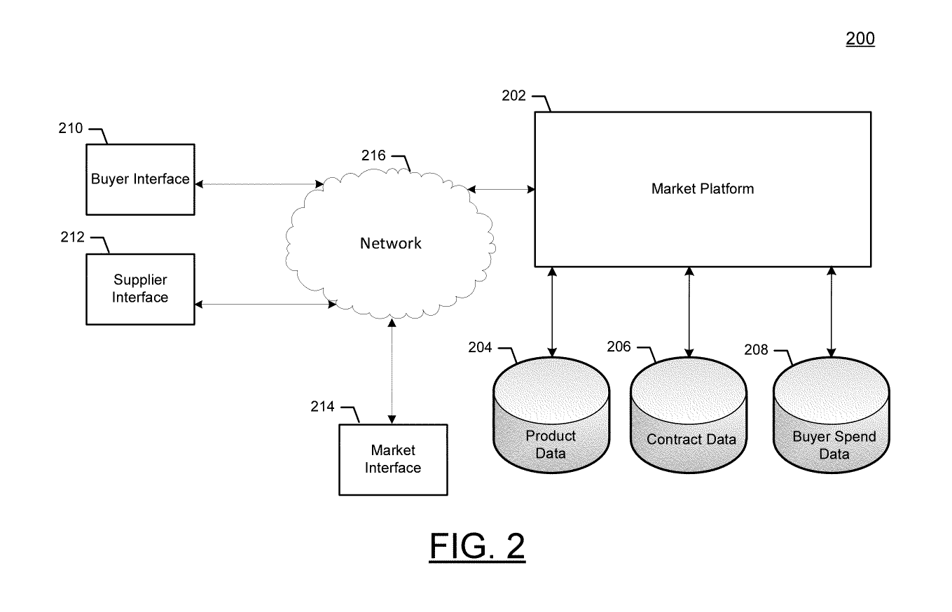

FIG. 1 illustrates a block diagram of an apparatus 102 in accordance with some example embodiments. The apparatus 102 may include a computing device that enables a market platform as described above. For example, the apparatus 102 may be implemented on one or more servers or other computing devices that may be configured to implement and control applications in accordance with various example embodiments. These applications may include hardware and software modules configured to receive market information, and to provide services related to the market platform as described above. As another example, the apparatus 102 may be implemented on one or more servers to provide a back-end interface and/or web interface in accordance with various example embodiments. Examples of computing devices that may correspond to the apparatus 102 are described further below with respect to FIG. 2. Accordingly, it will be appreciated that the apparatus 102 may comprise an apparatus configured to implement and/or otherwise support implementation of various example embodiments described herein.

It should be noted that the components, devices or elements illustrated in and described with respect to FIG. 1 below may not be mandatory and thus some may be omitted in certain embodiments. Additionally, some embodiments may include further or different components, devices or elements beyond those illustrated in and described with respect to FIG. 1.

The apparatus 102 may include or otherwise be in communication with processing circuitry 110 that is configurable to perform actions in accordance with one or more example embodiments disclosed herein. In this regard, the processing circuitry 110 may be configured to perform and/or control performance of one or more functionalities of the apparatus 102 (e.g., functionalities of a computing device on which the apparatus 102 may be implemented) in accordance with various example embodiments, and thus may provide means for performing functionalities of the apparatus 102 (e.g., functionalities of a computing device on which the apparatus 102 may be implemented) in accordance with various example embodiments. The processing circuitry 110 may be configured to perform data processing, application execution and/or other processing and management services according to one or more example embodiments. In some embodiments, the apparatus 102 or a portion(s) or component(s) thereof, such as the processing circuitry 110, may be embodied as or comprise a chip or chip set. In other words, the apparatus 102 or the processing circuitry 110 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 102 or the processing circuitry 110 may therefore, in some cases, be configured to implement an embodiment of the invention on a single chip or as a single “system on a chip.” As such, in some cases, a chip or chipset may constitute means for performing one or more operations for providing the functionalities described herein.

In some example embodiments, the processing circuitry 110 may include a processor 112 and, in some embodiments, such as that illustrated in FIG. 1, may further include memory 114. The processing circuitry 110 may be in communication with or otherwise control a user interface 116 and/or a communication interface 118. As such, the processing circuitry 110 may be embodied as a circuit chip (e.g., an integrated circuit chip) configured (e.g., with hardware, software or a combination of hardware and software) to perform operations described herein.

The processor 112 may be embodied in a number of different ways. For example, the processor 112 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. Although illustrated as a single processor, it will be appreciated that the processor 112 may comprise a plurality of processors. The plurality of processors may be in operative communication with each other and may be collectively configured to perform one or more functionalities of the apparatus 102 as described herein. The plurality of processors may be embodied on a single computing device or distributed across a plurality of computing devices collectively configured to function as the apparatus 102. In some example embodiments, the processor 112 may be configured to execute instructions stored in the memory 114 or otherwise accessible to the processor 112. As such, whether configured by hardware or by a combination of hardware and software, the processor 112 may represent an entity (e.g., physically embodied in circuitry—in the form of processing circuitry 110) capable of performing operations according to embodiments of the present invention while configured accordingly. Thus, for example, when the processor 112 is embodied as an ASIC, FPGA, or the like, the processor 112 may be specifically configured hardware for conducting the operations described herein. Alternatively, as another example, when the processor 112 is embodied as an executor of software instructions, the instructions may specifically configure the processor 112 to perform one or more operations described herein.

In some example embodiments, the memory 114 may include one or more non-transitory memory devices such as, for example, volatile and/or non-volatile memory that may be either fixed or removable. In this regard, the memory 114 may comprise a non-transitory computer-readable storage medium. It will be appreciated that while the memory 114 is illustrated as a single memory, the memory 114 may comprise a plurality of memories. The plurality of memories may be embodied on a single computing device or may be distributed across a plurality of computing devices collectively configured to function as the apparatus 102. The memory 114 may be configured to store information, data, applications, instructions and/or the like for enabling the apparatus 102 to carry out various functions in accordance with one or more example embodiments. For example, the memory 114 may be configured to buffer input data for processing by the processor 112. Additionally or alternatively, the memory 114 may be configured to store instructions for execution by the processor 112. As yet another alternative, the memory 114 may include one or more databases that may store a variety of files, contents or data sets. Among the contents of the memory 114, applications may be stored for execution by the processor 112 to carry out the functionality associated with each respective application. In some cases, the memory 114 may be in communication with one or more of the processor 112, user interface 116, and communication interface 118 via a bus(es) for passing information among components of the apparatus 102.

The user interface 116 may be in communication with the processing circuitry 110 to receive an indication of a user input at the user interface 116 and/or to provide an audible, visual, mechanical or other output to the user. As such, the user interface 116 may include, for example, a keyboard, a mouse, a joystick, a display, a touch screen display, a microphone, a speaker, a Light Emitting Diode (LED), a lighting device, and/or other input/output mechanisms. In embodiments in which the apparatus 102 is implemented on a server, aspects of the user interface 116 may be limited, or the user interface 116 may even be eliminated.

The communication interface 118 may include one or more interface mechanisms for enabling communication with other devices and/or networks. In some cases, the communication interface 118 may be any means such as a device or circuitry embodied in either hardware, or a combination of hardware and software that is configured to receive and/or transmit data from/to a network and/or any other device or module in communication with the processing circuitry 110. By way of example, the communication interface 118 may be configured to enable the apparatus 102 to communicate with another computing device via a wireless network, such as a wireless local area network (WLAN), cellular network, and/or the like. Additionally or alternatively, the communication interface 118 may be configured to enable the apparatus 102 to communicate with another computing device via a wireline network. In some example embodiments, the communication interface 118 may be configured to enable communication between the apparatus 102 and one or more further computing devices via the Internet. Accordingly, the communication interface 118 may, for example, include an antenna (or multiple antennas) and supporting hardware and/or software for enabling communications with a wireless communication network (e.g., a wireless local area network, cellular network, and/or the like) and/or a communication modem or other hardware/software for supporting communication via cable, digital subscriber line (DSL), universal serial bus (USB), Ethernet or other methods.

Having now described an apparatus configured to implement and/or support implementation of various example embodiments, features of several example embodiments will now be described. It will be appreciated that the following features are non-limiting examples of features provided by some example embodiments. Further, it will be appreciated that embodiments are contemplated within the scope of disclosure that implement various subsets or combinations of the features further described herein. Accordingly, it will be appreciated that some example embodiments may omit one or more of the following features and/or implement variations of one or more of the following features.

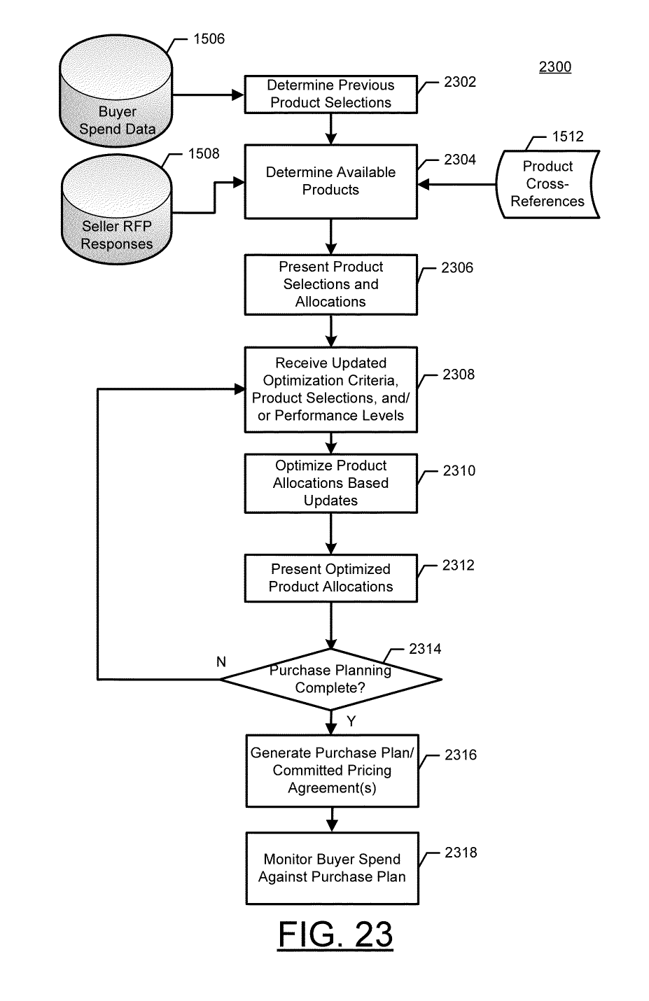

FIG. 2 depicts a block diagram of a system 200 for managing purchase contracts in accordance with some example embodiments. The system 200 may include several computing nodes or devices in communication with one another. Each of the devices may have the same or similar configuration to the apparatus 102 described with respect to FIG. 1. The system 200 may include a market platform server 202 in communication with one or more of a buyer interface 210, a supplier interface 212, a market interface 214 and/or other devices (not pictured). The market platform server 202 may send and receive data to and from these devices 210-214 to facilitate management of a supply market. In some embodiments, the market platform server 202 may be operable to capture data relating to transactions performed by the market platform server 202. This data may be used to derive a set of market analytics based on the transactions. For example, market analytics may be used to inform buyers of optimal product cross-references, or the market analytics may inform suppliers of buyer preferred contract parameters. Examples implementations of these analytics are described further below with respect to FIGS. 23-27.

The market platform server 202 may access one or more datastores. These datastores may include a product datastore 204, a contract datastore 206, and a buyer spend datastore 208. By accessing these datastores 204, 206, 208, the market platform server 202 may provide information to buyers and suppliers, manage contracts, and monitor compliance with said contracts for buyers and suppliers.

The product datastore 204 may include information describing products available from one or more suppliers. For example, in the medical field, HCOs may purchase tens of thousands of distinct medical and surgical supply products. These products may be purchased from hundreds or thousands of different suppliers. Such products may be organized into various categories relating to the type of product, the intended use of the product, or the like. For example, in the case of medical supplies and devices, products may be identified as belonging to a particular United Nations Standard Products and Services Code (UNSPSC). A category may be a pre-defined collection of one or more, and typically a plurality of, UNSPSCs. Categories may be pre-defined for a particular market ecosystem or may be pre-defined by the market. For example, products may be assigned to particular categories by the functionality of the product (e.g., products that protect the user from a particular hazard), by the construction of the product (e.g., products made of latex), by the intended use of the product (e.g., products used by surgeons during a heart surgery), general industrial knowledge, or by any other set of criteria. These categories may be established by an owner or maintainer of the market platform, or in communication with suppliers and/or buyers of the products. Product associations with particular categories may be mutually exclusive, such that any given product may only be associated with a single category. These categories may be further utilized to assist with a collection of buyer spend data, such that market share compliance may be based upon buyer spend in particular categories. Categories may include a plurality of related products and, in some embodiments, products may be associated with a single UNSPSC to assist with market share compliance measurements.

Product cross-references may be determined in a variety of ways (e.g., by user input, by supplier input where suppliers list products for which their products are equivalent, or the like), and there may be a variety of types of cross-references (e.g., exactly functionally equivalent for all uses, functionally equivalent for some uses). Although the cross-reference data stored in the product datastore 204 is described by example with respect to the medical supply field, the same techniques could be applied to other fields and industries, such as sports equipment, personal protective equipment (e.g., industrial gloves, masks, and aprons), manufacturing parts (e.g., auto parts), general contracting (e.g., nails, tools, lumber), school supplies, lab equipment, or the like.

The contract datastore 206 may include information pertaining to one or more contracts entered into by one or more buyer with one or more of the suppliers. These contracts may include products to be purchased, contract durations, item prices, and various compliance terms. The compliance terms may include various parameters, such as market share levels and associated prices. For example, a buyer may be entitled to purchase an item at a discounted price if they offer the supplier at least 80% market share of their spending in a particular product category (e.g., a particular UNSPSC). If the buyer only provides the supplier with 75% market share (e.g., the buyer purchases 200 items in the particular UNSPSC for a given compliance period, but only purchases 150 items from the particular supplier, or the buyer purchases $10,000 worth of product in a particular UNSPSC but only $7,500 from the particular supplier), the buyer may lose the discounted price, and the supplier may be entitled to recover the difference between the discounted price and the non-discounted price from the buyer, the supplier may be entitled to raise the price for the next compliance period, or other enforcement action may be taken, depending upon the contract parameters. The contract datastore 206 may also include price proposals offered by suppliers, but which are not accepted by the buyer. For example, the contract datastore 206 may store proposals created by the suppliers in response to a RFP generated by the buyer. As an alternative example of an over-compliance scenario, if the buyer were to purchase products equivalent to a 90% spend in a given market share, when the buyer only originally committed to an 80% category spend, the buyer might be presented with an additional discount for a next term, or a rebate equal to the difference between the discount level offered at an 80% market share versus the actual 90% market share.

The market platform server 202 may also be operable to receive spend data from a buyer spend datastore 208. In some embodiments, the buyer spend datastore 208 may be located at an external computing node from the market platform server 202. For example, the buyer spend datastore 208 may be implemented as a purchase order and invoicing or material management system used by the buyer to order products from one or more suppliers. The buyer spend datastore 208 may include an application programming interface (API) used to supply the spend data to the market platform server 202 as orders are placed or invoiced by the buyer. Although the buyer interface 210 and the buyer spend datastore 208 are represented as separate blocks in the illustration, these entities may also be implemented as a single entity, such as a computer node that provides both an interface to the market platform aspects of the market platform server 202 in addition to supplying the market platform server 202 with buyer spend data.

In some embodiments, the buyer spend datastore 208 may be an ERP system, and queries may be used to extract spend data from purchase orders. For example, Structured Query Language (SQL) queries may be performed at particular intervals (e.g., once a day, once a week, once a month), to extract item prices, quantities, model numbers, and the like, and report the extracted data as customer spend data. As alternative or additional examples, buyer spend data 208 may be provided to the market platform server 202 as a file periodically generated and/or extracted by a buyer. For example, a hospital may periodically generate a spend data file from invoice data. Such a file may be provided in a comma delimited format, such as a set of comma separated values (CSV) or a spreadsheet. As another additional or alternative embodiment, spend data may be placed in a particular storage location by the buyer (e.g., at a particular disk or network location), and periodically retrieved by the market platform server 202. The market platform server 202 may perform actions to normalize the data for generating analytics and/or benchmarks for the spend data across multiple buyers and/or suppliers. The market platform server 202 may also use the spend data to determine whether the buyer is meeting market share commitment levels (e.g., by comparing the total number of products purchased in a particular product category vs. the number of products in that category purchased from a particular supplier, or the total amount of spending in the particular category vs. the amount of spending with the particular supplier). Spend data may be tracked over a period of time, and beyond a particular month. For example, in some circumstances, buyer invoices may be reconciled beyond the month in which the purchase is invoiced, so spend data may be captured up to three months after the particular month, and invoices received during this time may be reconciled to the date in which the associated purchase was made.

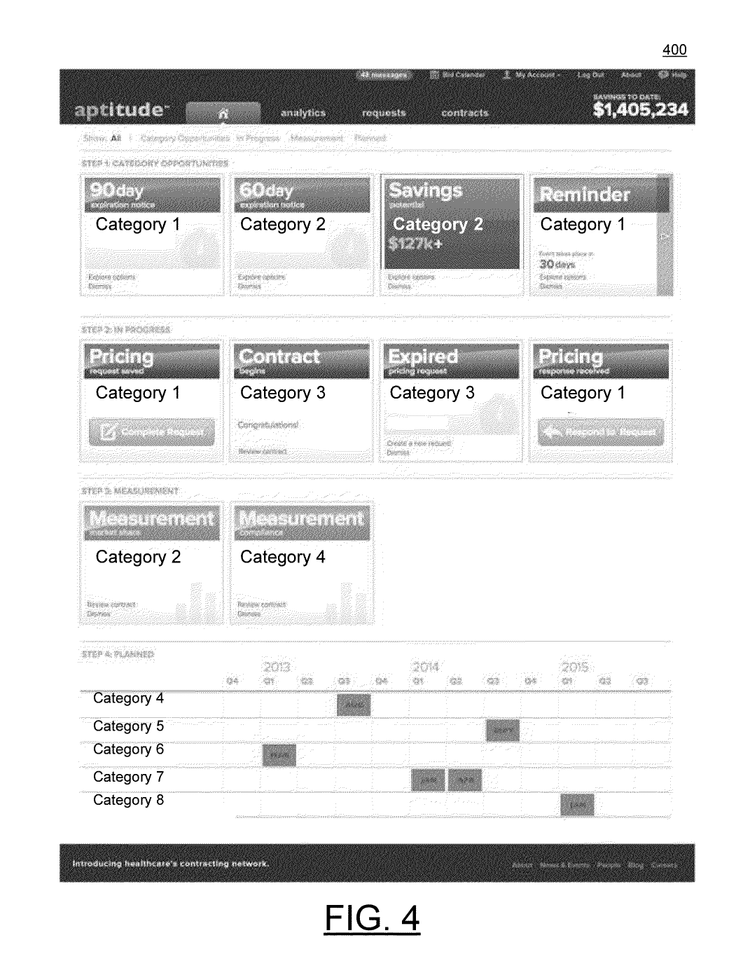

Buyers and suppliers may interact with the system 200 via a buyer interface 210 and a supplier interface 212, respectively. The buyer interface 210 may allow buyers to specify product supply needs to the market platform server 202, to review purchase plans generated by the market platform server 202, and enter into purchase contracts provided by suppliers. Contracts to which the buyer and supplier have agreed may be memorialized by the market platform as committed pricing agreements. These contracts may be generated by applying the terms of a particular pricing proposal to a template based on a set of rules, terms, and categories specified by the market platform. For example, prior to use of the market platform system, the buyer and supplier may each agree to certain base terms by which supply contracts generated by the system will be governed. When the buyer receives a response to a RFP, the price response may include a set of pricing terms. The buyer may make selections from these terms (e.g., market share commitment levels, contract duration, etc.), and apply these selections, along with pricing terms associated with said selections, to a committed pricing agreement template as defined within the previously agreed-to terms and conditions. The template with the terms from the pricing proposal applied may be used to generate a finalized committed pricing agreement containing contract language that includes the selected terms and associated prices. Buyers and suppliers may utilize e-signature technology to execute a committed pricing agreement generated by the system in this manner. The buyer interface 210 may also allow for viewing of analytics, benchmarks and compliance data derived from buyer spend data, so that buyers may monitor the status of their purchases and contracts. The buyer interface 210 may also enable buyers to create one or more RFPs to solicit pricing offers from suppliers. Examples of several screens and interfaces that may be provided by the buyer interface are provided below with respect to FIGS. 4-6 and 11-12.

The system may also include a market interface 214. The market interface 214 may provide administrative, management, and/or analytic services for interacting with the market platform. For example, the market interface 214 may provide access to analytic data generated by the market platform server 202 using the buyer spend data and contract information. The market interface 214 may provide an external or administrative user with access to various administrative and management functions, including but not limited to maintenance of user accounts and information, extraction of analytic data, generation of reports, or the like. In some embodiments, the market interface 214 may provide the ability to access analytic data to third parties external to the system.

In some embodiments, the buyer may utilize the buyer interface 210 to provide product cross-references to indicate similar or functionally equivalent products, and to rate and/or review products to notify other buyers of the performance of products they have used. The buyer interface 210 may include a login system that requires buyers to establish login credentials, ensuring that buyers only have access to their own data.

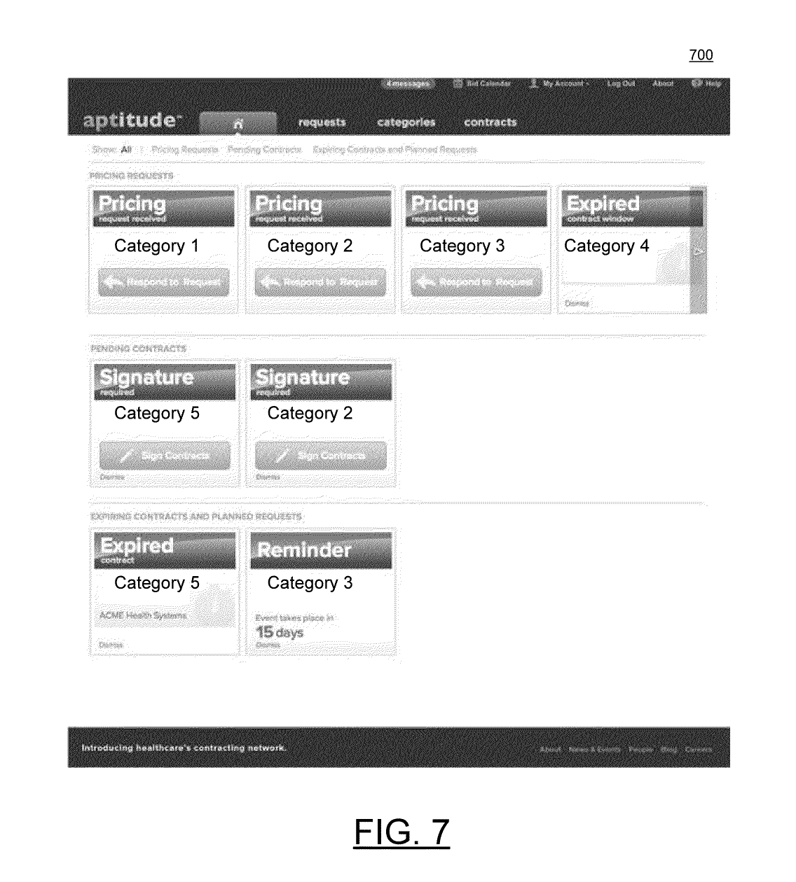

The supplier interface 212 may allow suppliers to provide data to the market platform server 202. Suppliers may provide information about their products, such as product names, product prices and/or pricing models. The suppliers may also use the supplier interface 212 to respond to RFPs initiated by buyers. RFP responses provided by the suppliers may include one or more pricing proposals for products related to the RFP (e.g., products identified by the buyer within the RFP, products associated with a category identified within the RFP, products associated with a category specified in the RFP and with the buyer's previous spending in the category, etc.), including contract parameters that are variable by one or more factors, such as the market-share example described above. The contracts may also include compliance provisions, payment provisions, penalties, and the like. Examples of several screens and interfaces that may be provided by the supplier interface 212 are described further below with respect to FIGS. 7-10 and 12.

The buyer interface 210, the supplier interface 212, and the datastores 204-208 may communicate with the market platform server 202 via a network 216. For example, the buyer interface 210 and the supplier interface 212 may be implemented as a web interface, accessible to buyers and suppliers via the Internet. As described above, the market platform server 202 may be configured to interface with a variety of computing devices located at the same or different nodes of the network 216.

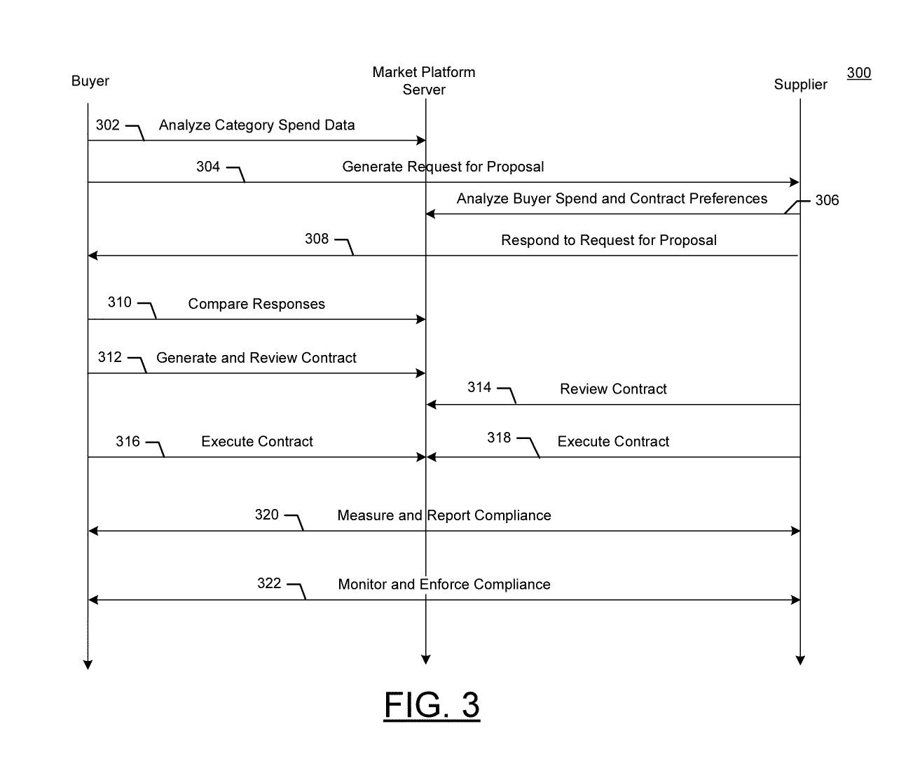

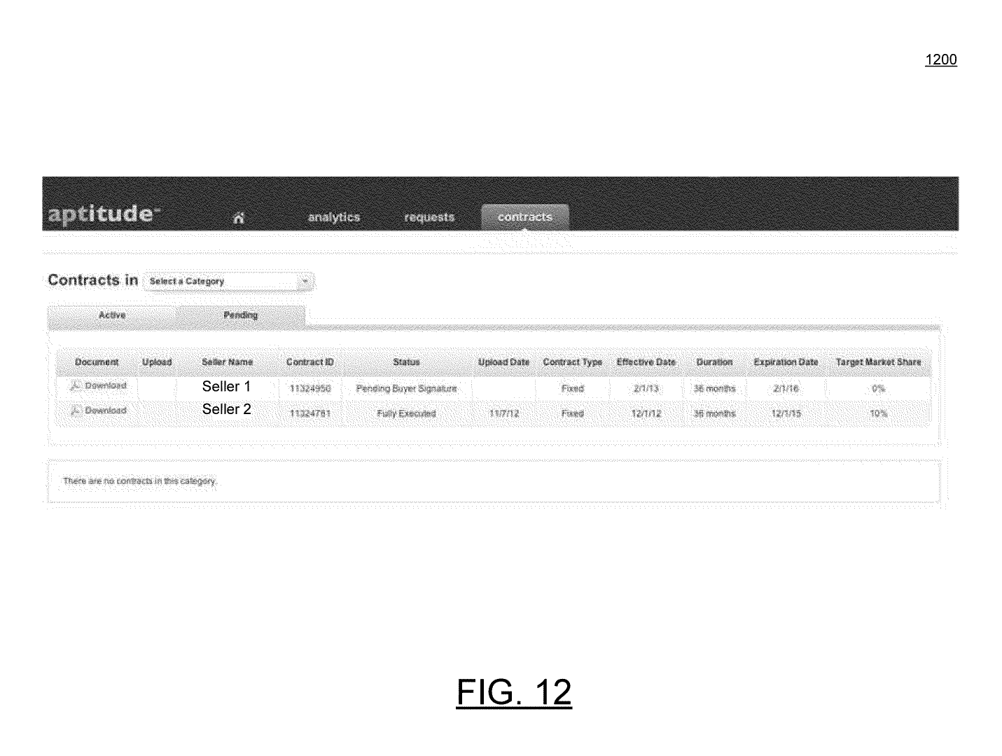

As described above the market platform server 202 may be operable to receive buyer product requirements in the form of one or more RFPs, to receive supplier price proposals in response to the RFPs, to generate a purchase plan for the buyer based on the supplier responses, to allow the buyer and supplier to enter into one or more contracts, and to determine compliance with the provisions of the entered contracts. Example methods for performing this functionality are described further below with respect to FIGS. 3 and 12.

FIG. 3 depicts a signaling diagram depicting messaging among a buyer, a supplier, and a market platform system in accordance with some example embodiments. The signal diagram 300 illustrates data flow among these entities throughout the market ecology established by the market platform system.

At action 302, the buyer provides spend data to the market platform system. The spend data may be associated with a particular category, such as with a particular UNSPSC in the category as described above. The buyer may provide their spend data to the market platform according to various formats. The buyer spend data may include product name, product identifiers and/or descriptions (e.g., Universal Product Codes, Universal Product Descriptions, supplier model numbers, stock keeping units), product manufacturers, equivalent products, market share commitment levels, and/or product volumes. In some embodiments, the buyer spend data may be provided in the form of one or more purchase order or invoices accessed and parsed by the market platform system. For example, the market platform system may communicate with a buyer ERP system to monitor and track invoices as products are purchased. For example, the buyer may provide a history of spend data (e.g., 3 months, 6 months, or 12 months of spend data) to the market platform, and the market platform may analyze the spend data to determine the parameters of the buyer needs. The market platform system may derive various analytics from the buyer spend data. For example, the market platform system may compare the buyer's spend data in a particular category against spend data for other buyers, or other buyers that share characteristic with the first buyer. This analytic data may be provided to the buyer to inform the buyer of where their product purchases in the particular category stand compared to all buyers and similar buyers. Such data may be useful to buyers to indicate particular products or categories that the buyer is spending more on or paying more than other buyers or other buyers with similar purchasing volume. This data may inform the buyer as to particular product categories for which the buyer may benefit from a price reduction or cost savings from soliciting proposals from suppliers to fulfill the buyer's needs in that category.

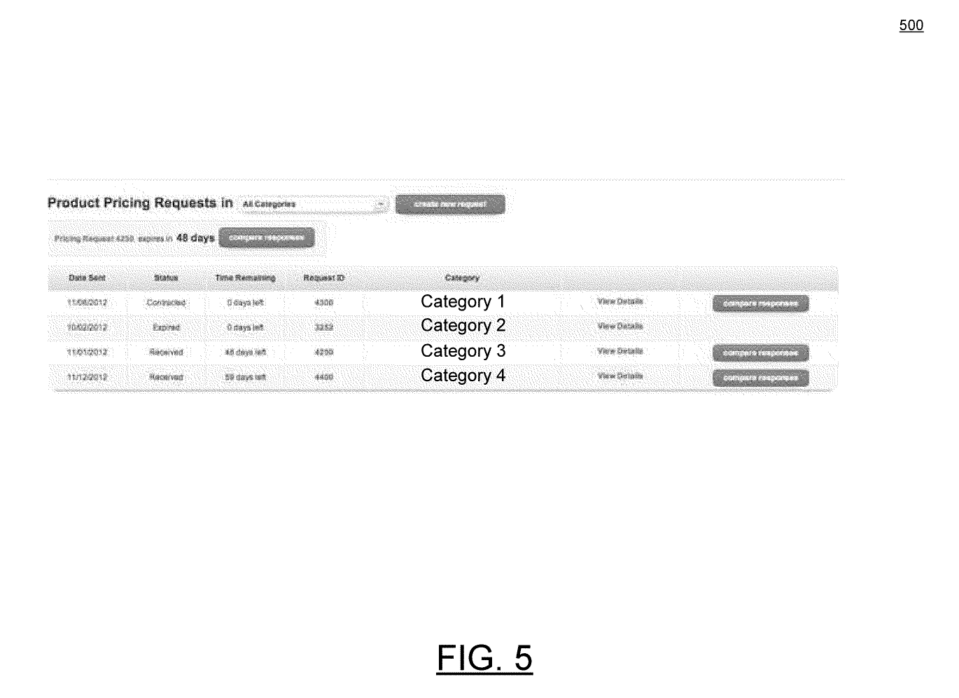

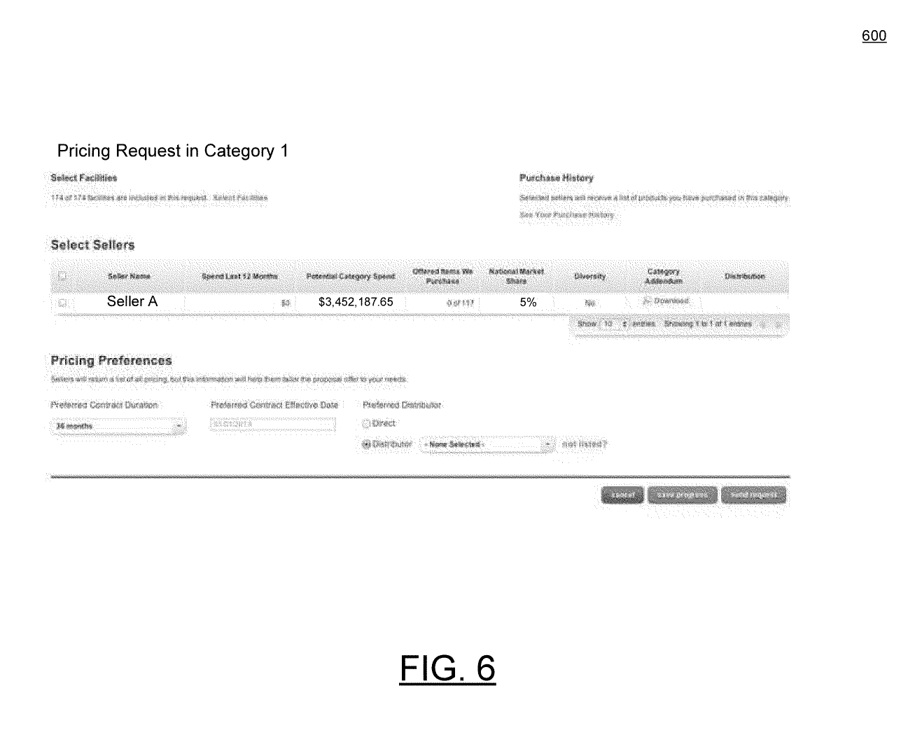

At action 304, the buyer generates an RFP and transmits the RFP to one or more suppliers via the market platform. As described above with respect to FIG. 2, the market platform may provide an interface by which the buyer can generate one or more RFPs for a particular category or categories and for a particular supplier or suppliers. The buyer may provide the market platform with the information necessary for generation of the RFP (e.g., product category, supplier name(s), buyer facility names), buyer contracting preferences (e.g., preferred duration, market share target, contract type, or the like) and the market platform may use the information to generate the RFP and notify the supplier. In some embodiments, the market platform may generate a notification to the supplier when the buyer creates the RFP, so that the supplier is aware of the RFP. The market platform may include a messaging interface to send a message to the supplier upon generation of the RFP, or the market platform may notify the supplier by additional or alternative means, such as by sending an e-mail to an address specified by the supplier. Example interfaces for generation of an RFP are described further below with respect to FIGS. 5 and 6.

At action 306, the supplier may examine the buyer's spend data and any contract preferences indicated in the RFP. For example, the supplier may be provided with data indicating the buyer's size, the buyer's historical spending in the particular product category, the buyer's desired contract duration, and/or any other factors that may be included in the RFP by the buyer. Examination of the buyer and the buyer's preferences in this manner allows for the supplier to make informed decisions about a pricing model or set of prices and a set of product prices to include in a response to the RFP. For example, if the buyer is a large entity or has a large amount of spending in the particular category of the RFP, then the supplier may be more inclined to offer a larger discount owing to the likely high volume of sales. Alternatively, the supplier may choose to be less flexible on price if the buyer is a smaller client.

At action 308, the supplier may respond to the buyer's RFP with a pricing proposal. The pricing proposal may include one or more prices for products in the category of goods requested by the buyer. These prices may be related to certain compliance terms. For example, prices may be based on buyer market share commitments, such that the greater the market share commitment offered by the buyer, the greater the discount offered by the supplier. Various other compliance terms may be included in the pricing proposal offered by the supplier. For example, the supplier may offer discounts based on contract durations or particular types of measurement and/or enforcement mechanisms. In some embodiments, the supplier specifies a maximum and minimum price for each product, with discounts offered within the maximum and minimum range.

At action 310, the buyer may compare responses provided by one or more of the suppliers. The market platform may provide tools for the buyer to perform this comparison. For example, the market platform may offer a graphic representation of prices at different market share levels to assist the buyer with selection of one or more of the proposals offered by the suppliers. The market platform may further offer tools for optimization of multiple contracts, or multiple contract term selections for a single contract, to assist the buyer with obtaining an optimal contract mix for the buyer's specific needs. For example, a first buyer may wish to focus on controlling costs as much as possible, even if controlling costs means accepting the inconvenience of many supplier contracts. This first buyer may instruct the market platform to identify a mix of proposals that offers the lowest aggregate costs. A second buyer may prefer to minimize the inconvenience of dealing with multiple suppliers, and may instead prefer a supplier mix that obtains as many products as possible from a single supplier. This second buyer may instruct the market platform to optimize a contract mix to minimize the number of suppliers. The market platform may offer various other tools and applications for assisting the buyer with comparing the proposals offered by the suppliers.

At action 312, the buyer may select one or more of the proposals offered by the supplier, and indicate to the market platform that the buyer wishes to accept the selected proposal. The market platform may thus initiate a contract between the buyer and the suppliers of the selected proposals based on the terms of the selected proposals. For example, the market platform may generate a document (e.g., a portal document format (PDF) file) for acceptance by the buyer and supplier, and notify the supplier that the buyer has accepted the proposal. The buyer may review this contract prior to final selection of the proposal, or the buyer may review the contract simultaneously with the supplier. At action 314, the supplier is notified of the accepted proposal and given the opportunity to review the contract.

At actions 316 and 318, the buyer and supplier each execute the contract. Execution of the contract may be performed electronically using the market platform, or the buyer and supplier may each indicate to the market platform when they have formally executed the contract. For example, the buyer and supplier may execute the contract in person or via traditional mail, and each indicate to the market platform when they have executed the contract. In response to receiving an indication of acceptance from both the buyer and supplier, the market platform may mark the contract as accepted and memorialize the accepted contract using the market platform. For example, a copy of the executed agreement may be scanned into the system.

At action 320, the market platform measures the performance of both the buyer and supplier, and monitors and/or enforces compliance with the terms of the contract. Measurement may be performed by continued monitoring of the buyer spend data, to determine if the buyer is meeting or exceeding the agreed upon market share commitment levels. In some embodiments, the market platform may inform buyers and suppliers of compliance levels, and allow the buyers and suppliers to determine on their own if terms of the agreement should be enforced.

At action 322, alternatively or additionally, the market platform may provide for enforcement measures. For example, enforcement may relate to measuring that the supplier is meeting their commitment to supply the buyer with goods in a timely manner according to the buyer's needs. Ongoing monitoring and enforcement may include adjusting product price levels in response to changes in the market share commitment levels met by the buyer, offering a rebate to the buyer if they exceed their market share commitment agreement, or other enforcement measures. This monitoring and/or enforcement may be performed at particular intervals, such as every 3 months, every 6 months, or every year. For example, the system may provide ongoing performance measurement for viewing by the buyers and suppliers, with particular quarterly milestones to report current compliance and allow the parties to take appropriate measures based on the compliance status.

To assist the supplier with responding to buyer RFPs, the market platform may offer various tools and techniques for generating product pricing data for consideration by the buyer. These tools may include a multi-dimensional array representation of discount levels for products within a category, with market share commitment levels, sales volume numbers, and/or other contract parameters along axes of the multi-dimensional array. Particular pricing models may be established for each product in a category or the category as a whole, and these pricing models may be provided in a format that allows for saving, loading, and copying of price information to simplify the process of responding to an RFP. Pricing models may also be associated with particular buyers or buyers of a particular size, or other buyer characteristics, to prevent the supplier from having to recreate the entire pricing model from scratch for every RFP.

The market platform may store data relating to purchase plans and pricing responses derived for buyers from one or more contract offerings provided by the suppliers. The market platform may provide a purchase planner for interacting with this data. The purchase planner may enable a buyer to view proposals offered by multiple suppliers and to examine different mix scenarios to identify an optimal set of proposals to meet the buyer's needs from the available proposals. The purchase planner may allow for the buyer to alter market share commitments and contract durations to determine the impact of the alterations on the buyer's overall purchasing. As the buyer changes commitment levels for a first proposal, the purchase planner may ensure that the buyer does not exceed 100% category market share commitment by adjusting other selected proposals as needed. The category market share commitment may be determined based on the supplier's maximum potential market share in the category, rather than the overall market share for the category. For example, a supplier may not offer a particular product or product cross-reference for an item in a category purchased by the buyer. Purchases of this product which the supplier does not offer would not be used to calculate the market share provided by the buyer in such a scenario. As such, buyer market share calculations may not be affected where suppliers provide different levels of coverage in a category. This also means that two or more contracts in a given category may be able to reach market share commitments that exceed 100% in aggregate, as different suppliers may not have overlapping coverage in the same category, such that purchasing a product from a first supplier does not reduce the market share of a second supplier. The purchase planner may also allow the buyer to “lock” certain proposals such that alteration of other proposals does not impact the locked proposals. The purchase planner may also allow the buyer to optimize for different contract mixes and to see the proposals that result in these optimal mixes. For example, the buyer may optimize for a maximum cost savings, minimum product conversion, a minimum number of suppliers, or various other contract mixes.

The market platform may include various applications, interfaces, and methods for enforcing compliance with the terms of contracts entered into between buyers and suppliers. These contract terms may relate to market share commitment levels, contract durations, other contract terms and conditions, enforcement terms and conditions, and the like. By reviewing and analyzing buyer spend data, the market platform may accurately determine whether both parties are meeting their obligations under the agreed-upon contracts. In the event that one or both parties are not in compliance (or in over compliance), the market platform may dynamically enforce the terms of the contract as specified in the original agreement.

For example, in a scenario where the buyer is not meeting an agreed-upon market share commitment for product purchases within a particular category, the market platform may notify the supplier of the under compliance, and provide the supplier with various options as specified under the original contract. These terms may include adjusting the price of the products for the next compliance period, requesting a payment from the buyer in the amount of the discount level that the buyer failed to meet, or various other contract measurement and/or enforcement methods. By ensuring compliance with the terms of the contract, the market platform advantageously provides suppliers with accurate data about compliance. Because suppliers are provided with accurate compliance data, the suppliers do not need to budget for possible unverifiable under compliance by the buyer, nor do the suppliers need to conduct audits to verify compliance. As such, suppliers may offer buyers lower prices or price rebates due to the accurate reporting of data.

FIG. 4 depicts a screen capture of a buyer dashboard interface 400 in accordance with some example embodiments. The buyer dashboard interface 400 provides a landing page for the buyer upon accessing the market platform. The buyer dashboard interface 400 may include one or more notifications to the buyer. For example, the buyer dashboard interface 400 as depicted in FIG. 4 shows several notifications to the buyer, such as contracts that are near the end of their term, ongoing contracts, the status of RFPs generated by the buyer, and upcoming events to be considered by the buyer.

FIG. 5 depicts a screen capture of a buyer RFP review interface 500 in accordance with some example embodiments. The buyer RFP review interface 500 may provide a buyer with a view of outstanding RFPs, and responses received to the RFPs. In this manner, the market platform may provide the buyer with a single interface for managing ongoing RFPs and to view the responses to each RFP. The RFP review interface 500 may further include an interface element that, when selected, initiates a new RFP from the buyer to one or more suppliers.

FIG. 6 depicts a screen capture of a buyer RFP generation interface 600 in accordance with some example embodiments. The buyer RFP generation interface 600 provides an interface that allows a buyer to enter contract parameters and discount terms for an RFP. The buyer may specify a particular product category, one or more suppliers, and preferred contract settings. The buyer RFP generation interface 600 may also provide seller profile data on suppliers selected by the buyer, such as indicating the supplier's total market share in the category, the supplier's total sales in the category, if the supplier meets minimum diversity standards, how many of the supplier's offered items are purchased by the buyer based on buyer spend data, the number of employees of the supplier, and the like. The buyer may select particular sellers to whom to issue RFPs based on these seller profile characteristics. For example, the buyer may solicit proposals from suppliers of below a certain number of employees, or suppliers that meet certain diversity standards.

FIG. 7 depicts a screen capture of a supplier dashboard interface 700 in accordance with some example embodiments. As with the buyer dashboard interface 400, the supplier dashboard interface 700 depicts a top level interface for providing notifications to the supplier. In the instant example, the supplier is provided with notifications of incoming RFPs for various product categories, notifications of contract proposals that have been accepted by buyers and that are awaiting signature by the supplier, and notifications of expired contracts and upcoming contract expirations.

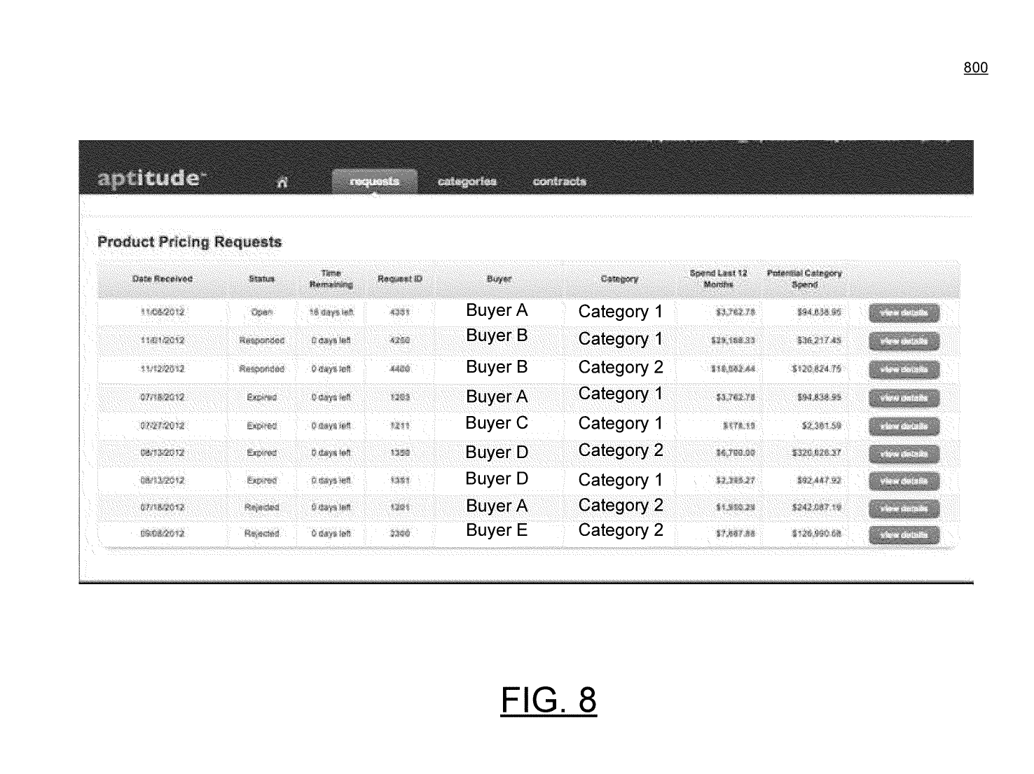

FIG. 8 depicts a screen capture of a supplier RFP review interface 800 in accordance with some example embodiments. The supplier RFP review interface 800 depicts incoming RFPs received from buyers. The supplier RFP review interface 800 thus allows for selection of particular RFPs so that the supplier may prepare a response to the RFP. The supplier RFP review interface 800 may also provide data about each buyer at a glance, such as the date the RFP was received, the date the RFP expires, the buyer's expected spend in the relevant product category, the status of each RFP, and the buyer's potential spend in the relevant product category if the buyer were to purchase all of the category's products from the supplier.

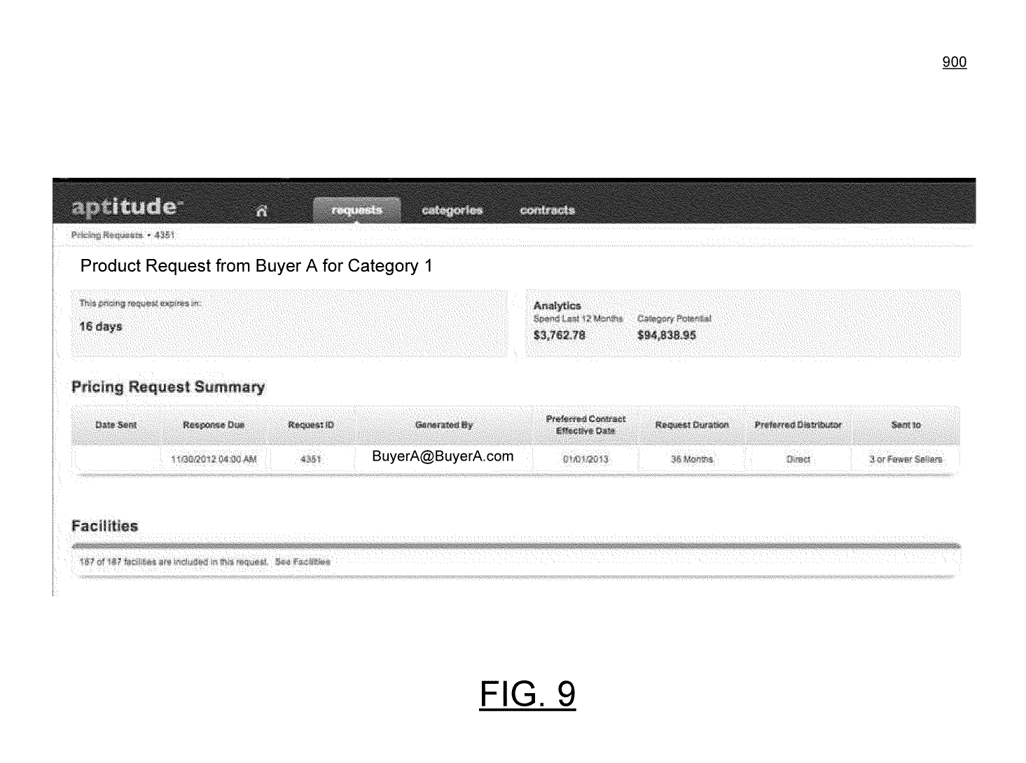

FIG. 9 depicts a screen capture of a supplier RFP detail view interface 900 in accordance with some example embodiments. The RFP detail view interface 900 may provide the supplier with in-depth data for a selected RFP, such as which of the buyer's facilities are included in the RFP, the identity of the buyer's point of contact in charge of the RFP, the buyer's preferred contract duration, and the number of suppliers involved in the RFP. The RFP detail view interface 900 may also provide an interface control allowing the supplier to craft a response to the RFP.

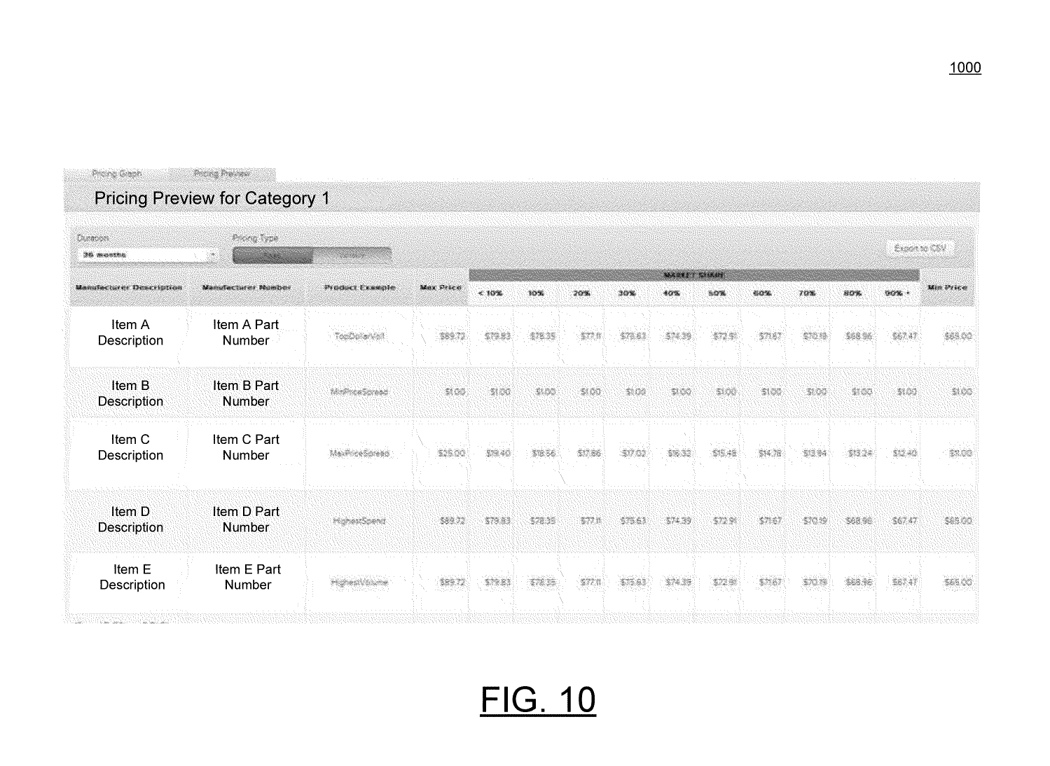

FIG. 10 depicts a screen capture of a supplier RFP response interface 1000 in accordance with some example embodiments. The supplier RFP response interface 1000 provides the supplier with a display of a pricing proposal that will be sent to a buyer in response to an RFP. The supplier RFP response interface 1000 may depict prices for one or more products in the category of the RFP, along with price discounts afforded due to conditions of the RFP, such as buyer market share commitments. The supplier may be able to alter various elements of the display to affect the response provided to the buyer, such as altering the base price of the product or the maximum product discount.

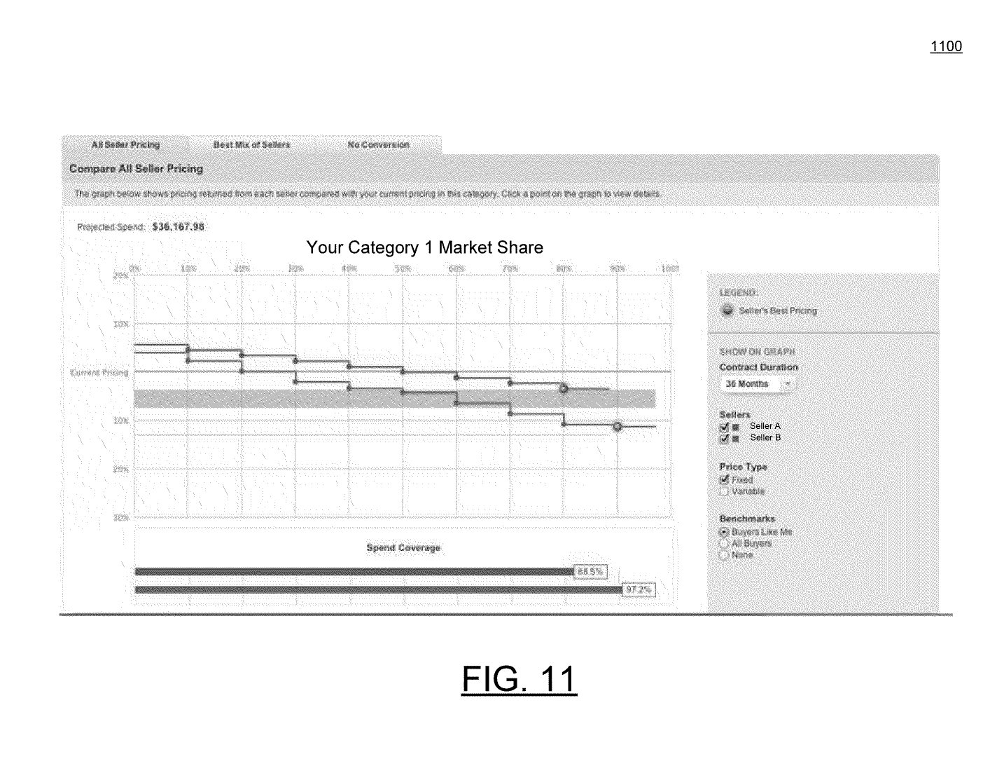

FIG. 11 depicts a screen capture of a RFP response review interface 1100 in accordance with some example embodiments. The RFP response review interface 1100 provides the buyer with a graphical display of supplier RFP responses to assist the buyer with selection of one or more of the proposals. The RFP response review interface 1100 may include visual interface elements, such as a graph of each proposal across various market share levels. The RFP response review interface 1100 may further allow for the buyer to view the proposed prices in relation to market price levels among all customers, or among customers with similar profiles (e.g., size, volume, type of buyer) as the buyer. The buyer may select different models for viewing of the optimal proposals. For example, a first view may highlight proposals that minimize overall cost, a second view may highlight a mix of proposals that provide the best mix across all suppliers, and a third view may highlight a set of proposals that avoid converting to new suppliers.

FIG. 12 depicts a contract status interface 1200 in accordance with some example embodiments. The contract status interface 1200 provides a status overview of contracts available or accepted by the party viewing the contract status interface 1200. For example, a buyer may view contracts that the buyer has previously accepted, and contracts the buyer has sent to suppliers for review in response to selection of a price proposal from an RFP response. A supplier may view contracts accepted by the supplier and contracts sent by the buyer for review and acceptance by the supplier. Each accepted contract may be associated with an interface element allowing the buyer or supplier to view the compliance status of the contract, based on spend data received from the buyer.

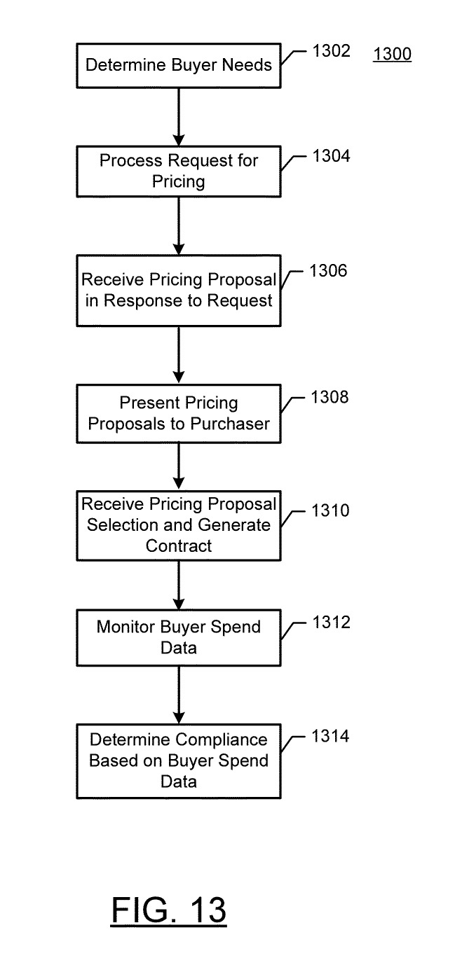

FIG. 13 depicts a flow diagram of an example method 1300 for implementing a market platform in accordance with some example embodiments. The method 1300 is an example of a process performed by a market platform, such as the market platform server 202, to assist buyers with requesting and selecting one or more contract proposals provided by one or more suppliers, and to assist suppliers with monitoring and enforcement of contract provisions, such as market share commitments.

At action 1302, the method receives a set of buyer needs. As described above, the buyer needs may be derived from a set of spend data provided by the buyer (e.g., 3 months, 6 months, or 12 months of spend data), or the buyer may manually generate a RFP to request pricing for a particular product, product category, or group of products/product categories. These needs may be identified based on purchasing efficiency analytics and benchmarks, examination of a contract bid calendar, identification of expiring contracts, or the like.

At action 1304, a RFP may be generated by the method in response to input received form the buyer at action 1302. The RFP may be provided to one or more suppliers to allow the suppliers to generate pricing proposals in response to the RFP.

At action 1306, the method 1300 may receive pricing information, such as contract parameters, in response to the RFP generated at action 1304. As described above with respect to FIG. 3, suppliers may present one or more pricing proposals to meet some or all of the needs of the buyer, and the market platform may analyze these pricing proposals to generate a purchase plan for the buyer.

At action 1308, the method 1300 may present the pricing options (e.g., a series of contracts with buyer's options one or more parameters) received from the suppliers to the buyer. The pricing options may be presented as a series of pricing proposals with different contract parameters and/or discount terms, or, as described above, the user may be presented with a purchase plan that provides a selection of optimal contracts or sets of one or more contracts for the user. Upon acceptance of one of these pricing proposals by a buyer, a contract may be generated from the terms of the pricing proposal.

At action 1310, the method 1300 may receive a selection of pricing options from the buyer. As described with respect to FIG. 3, the market platform may generate a contract or other committed pricing agreement from the selection. This selection may indicate that a contractual relationship has been entered into between the buyer and supplier at the terms specified in the selected contract.

At action 1312, the method 1300 may monitor buyer spend data to track compliance with the terms of the selected contract. In cases where compliance is based on market share, the method 1300 may determine market share levels by comparing the purchases of the product from each supplier with the total purchases of products in that product category from all suppliers. At action 1314, the data derived from the spend data (e.g., market share levels) may be compared against the terms of the contract to determine if the buyer is in compliance. In circumstances where the buyer is not in compliance, the market platform may notify the supplier to take appropriate action, or the market platform may automatically enforce the terms of the contract (e.g., by raising the price of the products, or by imposing a penalty on the buyer to be paid to the supplier in the amount of the contract deficiency).

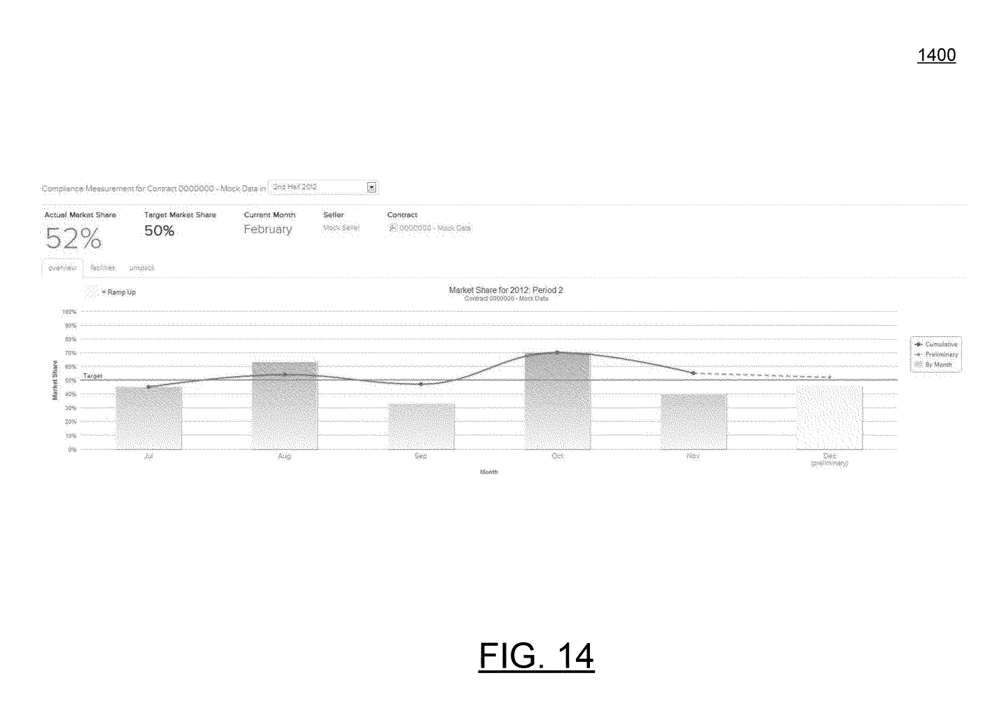

FIG. 14 depicts a screen capture of an example interface 1400 for monitoring contract compliance in accordance with example embodiments of the present invention. The interface 1400 allows for buyers and suppliers to view a graphical representation of the current compliance status. The image depicts a series of bars representing market share performance levels reached by the buyer over a series of compliance periods, such as over several months. A target commitment level is represented as a horizontal line at the commitment level target established during negotiation between the buyer and supplier. The interface further depicts an expected compliance level for upcoming review periods, and a cumulative compliance level that shows the overall compliance in aggregate. Individual values depict the current compliance level, the target commitment level, the current month, the seller, and various other parameters of a particular pricing agreement.

Although the compliance periods illustrated in FIG. 14 are related to particular months, such data may be aggregated over a longer period of time. For example, invoices and product orders placed in a particular month may not be fulfilled until a later time, and thus accurate tracking of performance may not be possible until fulfillment has occurred, even though the actual compliance occurs during the compliance period. As such, a sliding window for compliance periods may be established, such that compliance is measured for a certain period after the actual dates of the compliance period. For example, compliance for January may not be available until April, to allow for a two month window for any purchase orders or invoices prepared in January to be fulfilled. Furthermore, when initiating a new pricing agreement, it may not be practical to expect a buyer to perform according to their full market share commitment immediately. Contracts may thus include a ramp-up period for compliance measurement, such that enforcement and full monitoring is not enabled until the buyer and supplier have established a certain time period or number of transactions. The interface 1400 may provide a graphical representation of this ramp-up period, such as by cross-hatching compliance measurement bars during the ramp-up period. Compliance may be measured and reported in real-time, or at particular intervals. By measuring compliance in real-time, buyers and suppliers may be presented with accurate, real-time data that allows for ongoing adjustment to purchasing habits in order to meet with compliance goals.

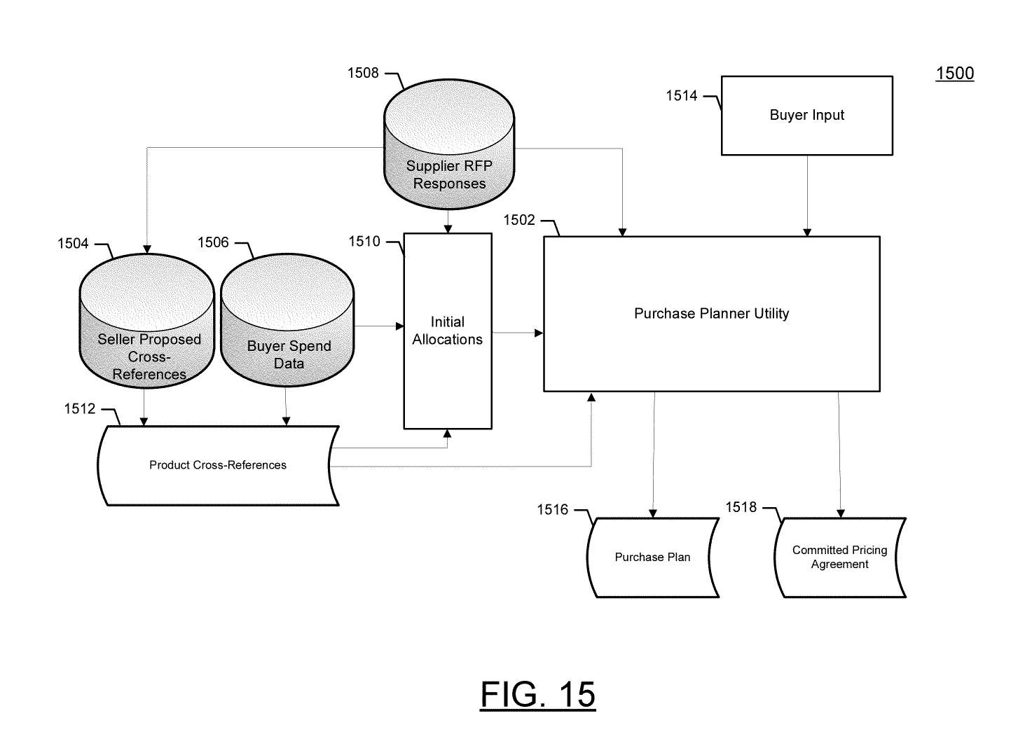

FIG. 15 depicts a block diagram of a purchase planning system 1500 in accordance with some example embodiments. As described above with respect to FIG. 2, a market platform may be operable to provide buyers with the ability to generate a purchase plan that reflects product selections, market share allocations for product selections, discount levels, and estimated spending in accordance with pricing proposals received from one or more suppliers. The purchase planning system 1500 depicts an example system for generating these purchase plans. The purchase planning system 1500 may include a purchase planner utility 1502 that generates a purchase plan 1516 and/or a committed pricing agreement 1518 using a buyer spend data 1506, seller RFP responses 1508, and user input 1514. The purchase planning system 1500 may be implemented by or executed on, for example, a market platform server, such as the market platform server 202 described with respect to FIG. 2.

The purchase planner utility 1502 may exist as a combination of hardware and/or software executing on a computing device. The purchase planner utility 1502 operates to determine a set of product selections, market share allocations within the product selections and contract commitment values to optimize spending for a buyer for a particular product, particular set of products, a product category, or a set of product categories.

Generation of the purchase plan 1516 may include analysis of one or more supplier RFP responses 1508. These supplier RFP responses 1508 may be received in response to a RFP generated by the buyer, as described above with respect to FIGS. 2-14. The RFP responses 1508 may include a list of products offered by the seller, and set of prices for those products according to various contract performance levels (e.g., market share commitments, sales volumes, contract durations). For example, a buyer may identify a particular product category for the RFP, and indicate to the supplier all of the products the buyer has previously purchased in that category according to the buyer's previous spending. The supplier may respond to the RFP with an RFP response that indicates which of the supplier's products are valid cross-references for the products identified by the buyer in the RFP.

A set of seller proposed cross-references 1504 may be stated in the supplier RFP responses 1508, or these seller proposed cross-references 1504 may be received directly from the supplier. For example, a supplier may provide the market platform with a list of all of their products, along with a list of which competitor products currently purchased by the buyer they believe are valid cross-references. Additionally or alternatively, such information may be provided with the seller RFP responses, or the seller RFP responses may identify particular products as cross-references based on the request submitted by the buyer. For example, in generation of the RFP, the buyer may indicate that their previous spending in the category related to three particular products, and the seller may respond in the RFP response by indicating which of their products they believe will serve as cross-references to the three products requested by the buyer.

The system 1500 may also include a set of buyer spend data 1506, such as the buyer spend data 208 described above with respect to FIG. 2. The buyer spend data 1506 may include historical spending data received from the buyer that is generating the purchase plan, other buyers that utilize the market platform for purchasing, and/or any other buyer spend data. This buyer spend data 1506 and product selections derived from purchase plans generated by other buyers may be analyzed to determine which products buyers generally select as cross-references. For example, the buyer spend data 1506 may track that, when buyers are presented with a choice between two particular products for inclusion in a purchase plan, buyers generally choose one or the other. The more frequently chosen product may be identified as a “crowd-sourced” or “community” cross-reference. In this manner, cross-references may be dynamically generated by the system 1500. Additional cross-reference types may include secondary supplier cross-references, where sellers provide additional cross-reference products for a given source product aside from their primary or “suggested” cross-reference product, highest rated cross references which are based on explicit user ratings and lowest cost cross-references, showing the lowest-cost cross-reference across all suppliers.

The system 1500 may thus generate a list of product cross-references 1512. These product cross-references may include all valid cross-references for a particular pricing response or set of pricing responses, or the list of product cross-references 1512 may be a global list that is equally applicable across all potential purchase plans.

The buyer spend data 1506 may also be used to derive a set of initial allocations 1510. The initial allocations may include the buyer's current product selections, supplier selections, and product purchase allocations. These initial allocations may be used as a baseline to provide a starting point for generating the purchase plan. For example, these allocations may be derived from the buyer's current spending on the products associated with the RFP, and the initial allocations may reflect the buyer's product selections, sales volume, and product purchase allocations. The product purchase allocations may reflect which products the buyer intends to purchase to meet the need for a particular product identified in the RFP, or in the product category identified in the RFP. For example, a buyer may have a need for latex gloves, and several suppliers may offer gloves that are valid cross-references for the type of gloves the buyer was previously purchasing. The buyer may allocate their spending across all three suppliers, with 20% of their spending related to latex gloves from Supplier A, 30% of their spending related to latex gloves from Supplier B, and 50% of their spending related to latex gloves from Supplier C. In some embodiments, the total allocation values represent a percentage of a previous spending for a particular product. For example, if a buyer knows that they are likely to have a greater need for the particular product, the buyer may provide product allocations that total greater than 100%, reflecting an increase in purchasing of the product over the previous measurement period. Conversely, if the buyer knows that there is likely to be less of a need for the product moving forward, the buyer's product spending allocations may total less than 100% to reflect a decrease in spending on that product for the next measurement period. Alternatively, product allocations may reflect a percentage of spending moving forward, such that a 20% allocation reflects a desire to purchase 20% of the buyer's future needs for that particular product. In circumstances where the product allocations reflect a percentage of spending moving forward, such allocations would have a maximum value of 100%, though the buyer might still have a total of less than 100% to present a conservative estimation of their purchasing (e.g., allocations that reference a purchase of a minimum spending allocation on a product, rather than a goal value).These initial allocations may also be derived from the supplier RFP responses 1508. For example, when considering a purchase plan, the buyer may be presented only with products that are associated with suppliers that responded to the buyer's RFP. In some circumstances, this may result in alternative products being suggested to the buyer for the initial allocation, as the buyer's current supplier may not have responded to the RFP. Additionally or alternatively, certain optimization techniques may be performed to generate the initial allocations. For example, the initial allocations may be modified to provide the buyer with a lowest overall cost based on the seller RFP responses received, or any other optimization technique as described above. In some embodiments, the buyer may be provided with an interface to select the method of determining the initial allocations, or the buyer may be prompted to manually enter initial values. It should be readily appreciated that various methods, algorithms, and weighting techniques can be employed to generate the initial allocations for generating the purchase plan.

In some circumstances, it may not be possible to derive the initial allocations directly from buyer spend data. For example, products previously purchased by the buyer may no longer be available. In such cases, the initial allocations may make use of the cross-references, such as supplier-provided cross-references, to match the supplier's products to the buyer's current products. Additionally or alternatively, such methods may be employed even when the buyer's current products are available, in order to present the buyer with a full range of selections in the product selection and allocation process.

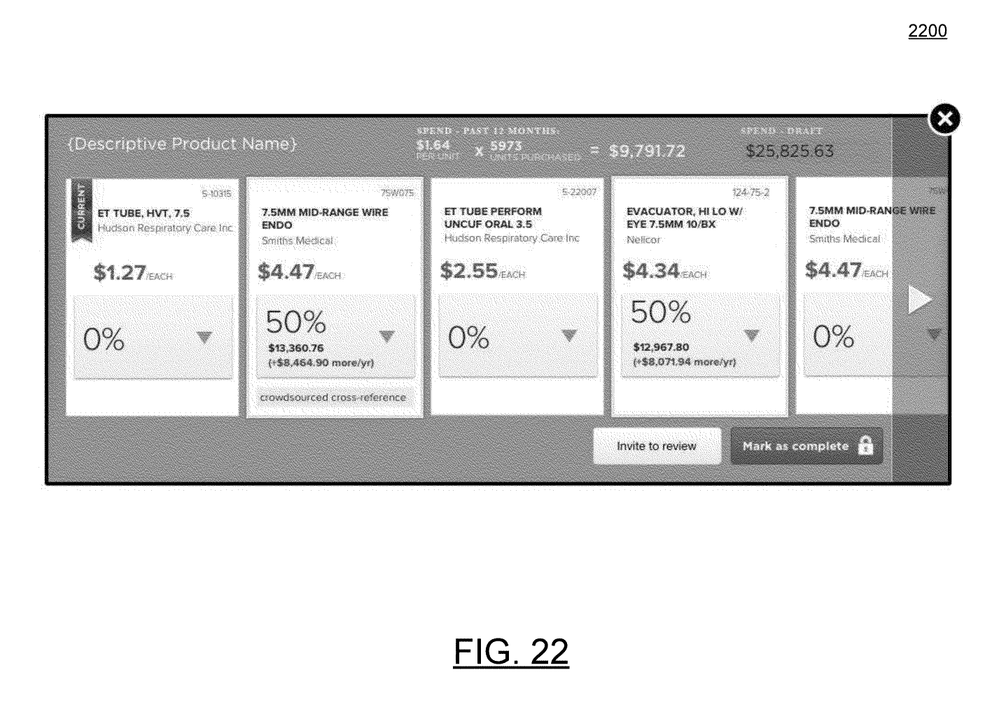

The purchase planner utility 1502 uses the initial allocations 1510, the seller RFP responses 1508, and the list of product cross-references 1512 to present the buyer with an interface for generating the purchase plan 1516. The interface may be populated with a list of sellers that provided RFP responses or a subset of the sellers that provided RFP responses, along with the products referenced in those responses. As described above, buyers may identify a particular category for the RFP, and the supplier may be presented with a list of all products previously purchased by the buyer in the category. The seller may thus recommend product cross-references for the products previously purchased by the buyer. As an alternative, the buyer may provide the seller with particular product selections for which the buyer desires a price proposal. As another alternative, the buyer may be presented with a list of products offered by the seller, alongside of the products the buyer initially selected for the RFP, so that the buyer may select from among product cross-references that may substitute for the initially requested product. An example interface for selecting among product cross-references is described further below with respect to FIG. 22.

The buyer may be provided with an interface to view the initial allocations 1510 and a spending plan derived from those initial allocations in view of the supplier RFP responses 1508. For example, the initial allocations 1510 may be used to determine the pricing of the associated products present in the RFP, and indicate to the buyer how much the buyer would be charged if they made no changes to their current spending. The interface may allow for the buyer to select cross-reference products and to see the impact of these selections on their planned spending. The buyer may also be presented with the ability to alter performance parameters such as contract durations or product allocations and to see the impact of these alterations on their planned spending, the market share the allocations will afford to each supplier, and the discount levels that may be offered by the suppliers based on the product selections and allocations. Finally, the buyer may be presented with interface controls to optimize their spending according to various optimization parameters. These optimization parameters may further include the ability to “lock” the product selections and spending allocations for a particular product or supplier such that the particular product or supplier is not modified for subsequent optimizations. The interface may thus allow for buyer input 1514 to modify these various parameters and selections to allow the buyer to determine their preferred selections for generation of a purchase plan.

After modifying the product selections, supplier selections, and product spending allocations to the user's satisfaction, the user may confirm the purchase plan. Completion of the purchase plan may result in the generation of a purchase plan 1516 and one or more committed pricing agreements 1518. For example, the buyer may confirm the purchase plan once the buyer is satisfied with the product selections, allocations, and contract terms, or the buyer may indicate to the system that the currently displayed terms should be used to generate a set of contracts for review. Although the purchase plan 1516 is generally described as an artifact generated by the purchase planning utility 1502, it should be understood that the interface output of the purchase planning utility 1502 may also be thought of as a “purchase plan” as the user edits and reviews the interface. In other words, the purchase plan may be thought of as the intermediate product selections and spending allocations generated and viewed by the buyer, in addition to a particular finalized set of product selections and spending allocations generated when the buyer chooses to generate the contracts. The purchase plan 1516 may include planned product selections, spending amounts, and product spending allocations for each of the committed pricing agreements to ensure that the buyer can be regularly apprised of their progress towards meeting the commitment levels outlined in the purchase plan. A given purchase plan 1516 may be associated with a particular RFP, though other implementations might associate a single purchase plan with all buyer spending in a particular category, or all buyer spending globally. For example, such a category or global purchase plan might be dynamically loaded and updated as the buyer completes multiple RFPs. A purchase plan associated with a particular set of products or product categories may persist across multiple RFPs for the set of products or category, as supplier contracts within a category may be executed at different times. A purchase plan associated with an earlier RFP for the set of products or category may be used to inform purchasing decisions, future purchase plans, and supplier contracts made in as a result of future RFPs for the set of products or category. The term purchase plan should be generally understood to refer to a set of one or more spending allocations for one or more products. These products may be included in a single category, across multiple categories, in a user defined category, or by any other method of organizing or grouping products within the system. Purchase plans may be displayed in an interface as the user completes a purchase planning process, or purchase plans may be stored for later reference and used to measure ongoing spending against the purchase plan. The buyer may be provided with regular status reports and updates based on the purchase plan to notify the buyer if they are on track to meet their planned spending.

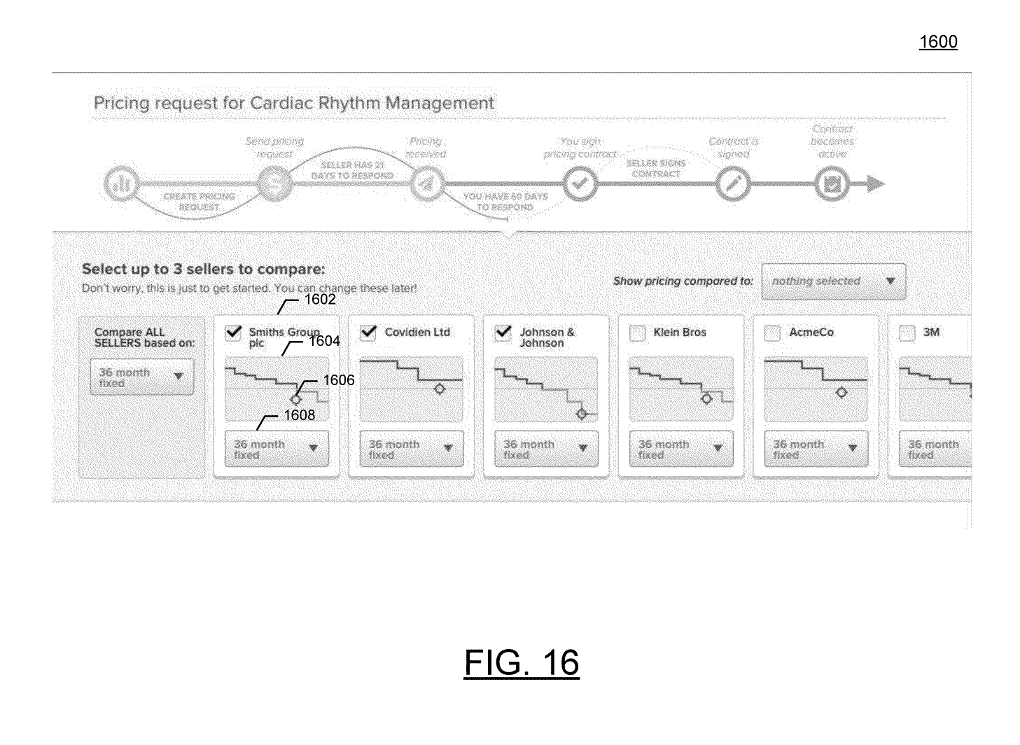

FIG. 16 depicts a screen capture of an interface 1600 for selecting suppliers for comparison in accordance with some example embodiments. Prior to generating the purchase plan, the buyer may be presented with the opportunity to select a subset of suppliers for review and optimization. Additionally or alternatively, the interface 1600 may be provided to allow the buyer to perform a direct comparison between suppliers, separately and distinctly from the purchase planning process. For example, the buyer may use the interface 1600 to select suppliers for a best estimate comparison in a single graph or chart. The interface 1600 provides a display whereby the buyer may select from the suppliers that have responded to the RFP, for inclusion in the purchase plan. The buyer may also be presented with the option to select certain contract parameters such as, in the present example, a contract duration. Each supplier may be associated with a particular supplier icon 1602 for selection. For example, in the present display, each seller has a checkbox icon the user may mark to select the supplier for comparison. Each seller may also be accompanied by a graph 1604 that illustrates the supplier's discount level for a particular contract parameter. For example, the interface 1600 displays the supplier's price levels as market-share commitments increase. The graph 1604 may also include a marker 1606 for indicating the best discount offered by that supplier. The marker 1606 may not be presented on a displayed graph if the best discount is offered by a contract with different parameters than displayed. For example, if the supplier's best discount is offered on a 48 month duration contract, the marker 1606 would not be displayed on the actual line of the graph associated with a 36 month duration contract. The buyer may be provided with an interface control 1608 for adjusting these parameters, such as the duration in the present example, to modify the displayed graph.

When selecting suppliers for entry into the purchase planning interface, the buyer may also be presented with additional information about each supplier. For example, the buyer may be shown each supplier's ability to cover the buyer's planned spending in a particular category. Alternatively, the purchase planning interface may examine prices for each seller suggested cross-reference for each duration, contract type, market share, or the like provided in a pricing response to determine a maximum discount level and suggested spending. The initial comparison may thus provide high-level estimates of seller coverage, likely spending, and savings offered by each seller. The interface may further identify the minimum commitment parameters that would generate the best pricing, to allow the buyer to select the lowest commitment level that achieves the best discount level and to use the associated target market share, duration, and contract type as an initial allocation.

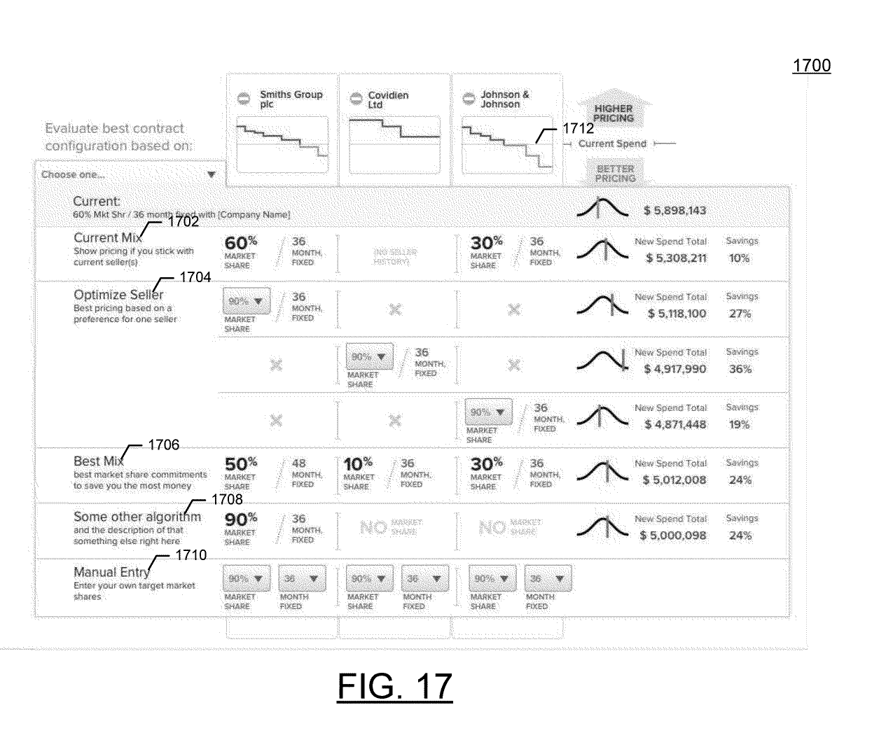

FIG. 17 depicts a screen capture of an interface 1700 for generating initial allocations for a purchase plan in accordance with some example embodiments. As described above, the user may be presented with a set of initial values to generate initial allocations for a purchase plan. These initial values may be derived from previous buyer spend data, or in response to selection of a particular optimization technique. The interface 1700 provides a buyer with the ability to select how the initial allocations will be generated. In the present example, the interface is populated with the user's current spend data for the product or set of products, along with data for selected suppliers, such as suppliers selected using the interface 1600 described above with respect to FIG. 16.

The interface 1700 displays to the buyer several interface controls for selecting a contract configuration. Each interface control may be displayed along with an example optimized set of contract parameters associated with the interface control, along with an estimate of the total savings provided by the mix of contracts associated with that interface control.

In the present example, the buyer may select the current mix control 1702 to populate the purchase plan with pricing based on if the buyer stays with their current suppliers. In the instant plan, that would result in the buyer providing a 60% market share commitment to Supplier A, and a 30% market share commitment to Supplier C. Since the buyer does not currently buy any products that are the subject of the RFP from Supplier B, the appropriate field is left with a blank market share commitment and the statement “No History”, to indicate as such.

The buyer may also select a control to optimize a contract mix for a particular supplier. This optimize supplier control 1704 allows for the buyer to populate the initial allocations with data that will maximize the discount for a particular supplier. Since optimizing for a first seller may typically result in sub-optimal pricing for other suppliers, the optimize supplier control 1704 may only allow for selection of a single supplier at a time.

The buyer may select a best mix control 1706 to optimize the initial allocations to result in a highest savings for the buyer. This control may identify the optimal mix by measuring the discount across various permutations and combinations of product selections and contract parameters for all of the selected suppliers. For example, the purchase planner may conduct a “Monte Carlo” simulation, simulating discount levels over ten-thousand or more possible contract scenarios, and presenting the scenario with the greatest overall savings to the user for use as the initial allocations, or various other combinatorial optimization algorithms may be employed to determine maximum overall savings for the buyer. As another example, a set of heuristics may be used with a combinatorial optimization algorithm to lower the complexity of the optimization process.

The interface 1700 may also include various other controls 1708 for various other optimizations not explicitly displayed in the interface 1700. For example, alternative optimization techniques might optimize for selection of highest rated products, selection of products that provide maximum sustainability or minimal environmental impact, selection of products from suppliers that meet certain diversity criteria, or any other method that may rely on various data analysis techniques.

The interface 1700 may also include a control or set of controls to allow the buyer to manually input values. These manual input controls 1710 may allow for the buyer to select contract performance parameters such as manual product selections and spending allocations, or a contract duration for each supplier, and use these selections to provide the initial allocations.

The interface 1700 may also display a series of graphs 1712 associated with each supplier. As described above with respect to FIG. 16, supplier discounts may be represented as graphs with a first axis for a discount value, and a second axis for a contract performance parameter (e.g., market share commitment). The graphs 1712 depict the buyer's discount level, with a line representing the buyer's performance based on previous spending levels.

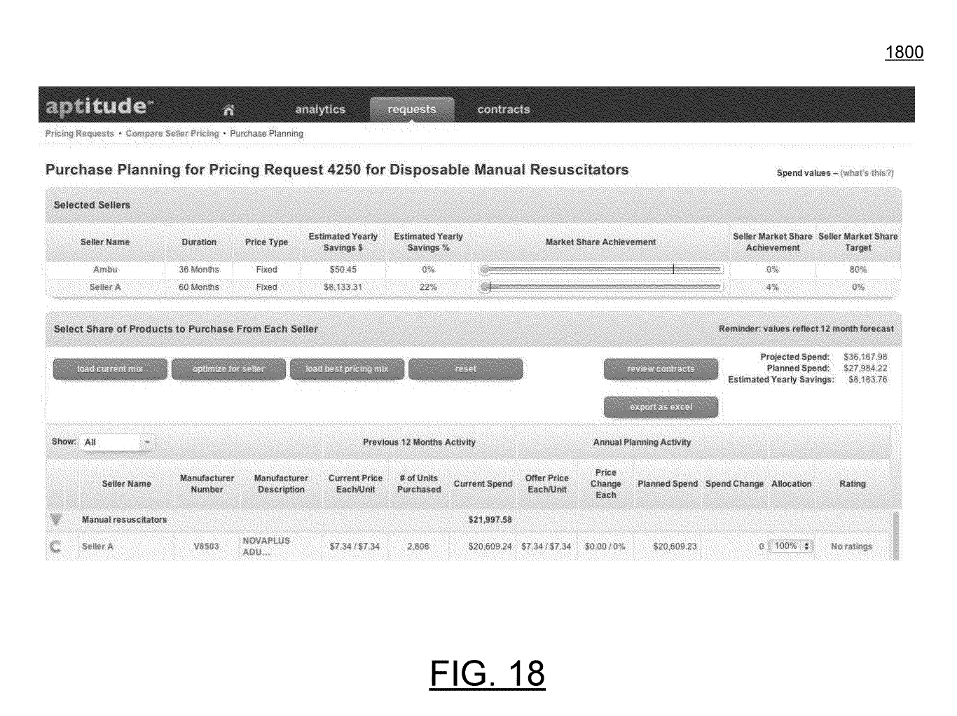

FIG. 18 depicts a screen capture of an alternative interface 1800 for selecting products and product spending allocations for a purchase plan in accordance with some example embodiments. As with the interface 1700 described above, the interface 1800 provides the ability for the buyer to select an initial allocation for later modification and generation of a purchase plan. This initial allocation may be performed according to a variety of factors, such as selection of a current mix, optimization for maximum savings, or manual input. The interface 1800 also illustrates how achievement may be measured towards a target goal. “Thermometer” displays may represent a market share achieved to date for the purchase planning operation, as compared to a target market share goal.

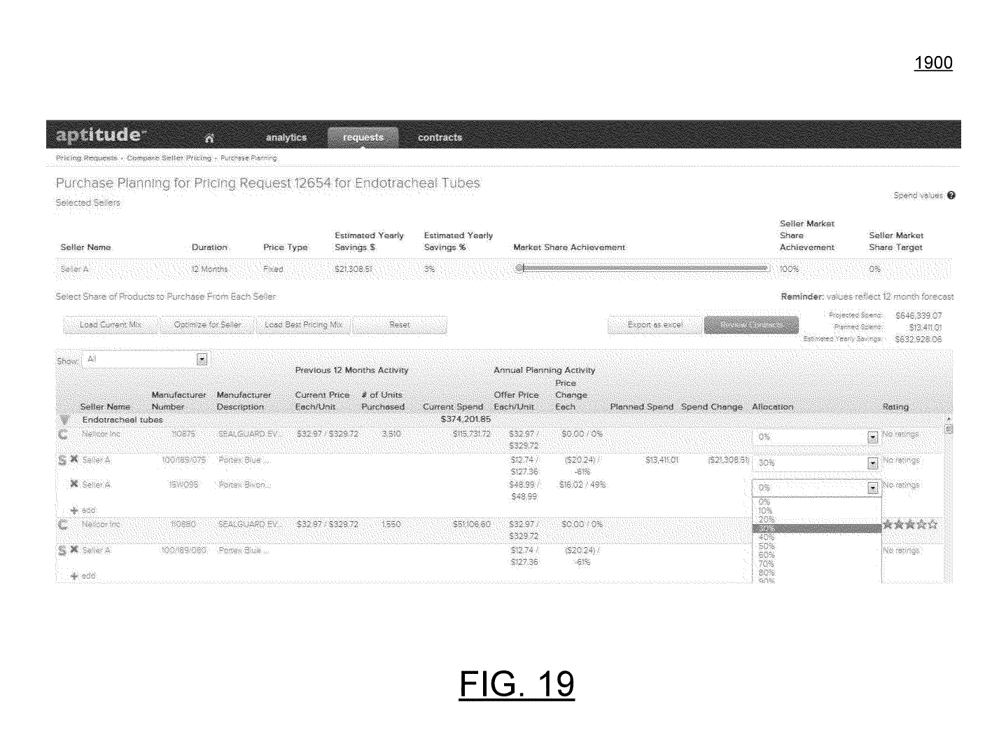

FIG. 19 depicts a screen capture of an interface 1900 for modifying allocations associated with a purchase plan in accordance with some example embodiments. As described above, the buyer may be presented with an initial set of allocations based on a various factors. These initial allocations may be presented to the buyer for modification. As described above, the purchase plan may include both a final artifact generated by a utility for ongoing measurement and monitoring of spending, or an intermediate construct used for simulation and/or planning purposes as the buyer interacts with the purchase planning utility. These initial allocations may thus function as a starting point, allowing the buyer to modify the products selected, the spending allocations for each selected product, the suppliers selected, and the associated contract performance parameters and see the results of these modifications dynamically. For example, the interface 1900 depicts a set of products and available cross-reference products. The buyer may select which of these products they wish to purchase by adjusting the allocations presented in drop-down menus, and how much of their spending for that particular set of products they wish to allocate to each product. As these allocations are updated, the buyer may be provided with updated pricing based on the new allocations. The buyer may be further presented with indicators indicating that some products are seller-identified cross-references, crowd-sourced cross-references, rating-derived cross-references, or products that are currently purchased by the buyer.

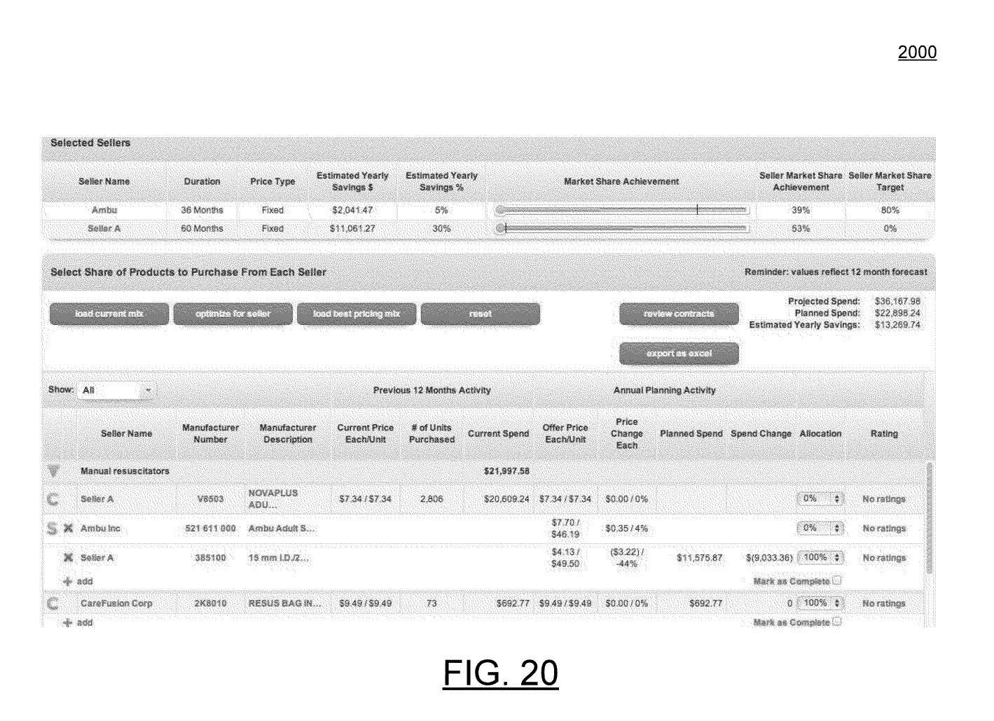

FIG. 20 depicts a screen capture of an alternative allocation modification interface 2000 in accordance with some example embodiments. The interface 2000 provides another example of an interface for modifying allocations prior to generation of a purchase plan. The interface 2000 shows the dynamic impact on market share across two sellers as product selections and market share allocations are changed in the interface. As above, the buyer may be presented with an interface 2000 that allows for optimization of the product selections and spending allocations based on various factors, or manual modification of said allocations.

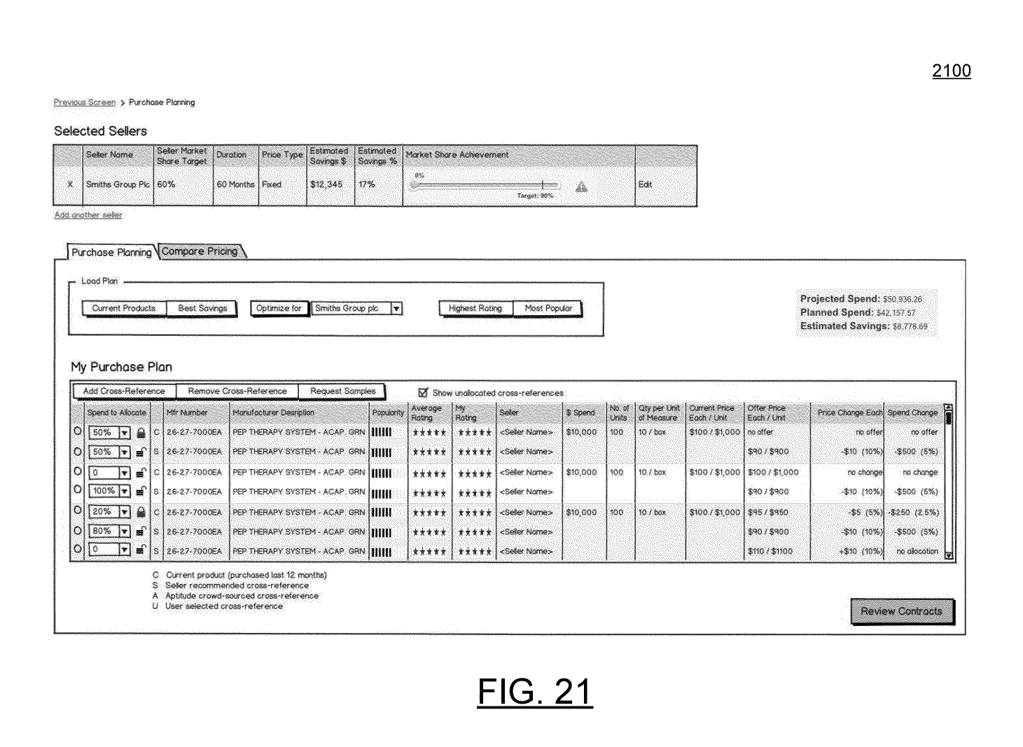

FIG. 21 depicts a screen capture of an example purchase plan interface 2100 in accordance with some example embodiments. The interface 2100 shows a purchase plan that allows for modification or optimization. In the instant example, several products have been selected and had spending allocated, and the buyer may select the “review contracts” interface control to proceed with generation of contracts based on the selected products and spending allocations. As above, the buyer may be presented with the ability to modify the product selections and spending allocations and/or optimize for alternative factors as provided in the interfaces 1900 and 2000. Cross-reference products may be presented to the user with icons indicating the source of the cross-reference. Contract parameters, such as the market-share commitment offered to each supplier, may be derived from the product selections and spending allocations selected by the buyer. In some embodiments, the buyer may go through multiple optimization steps, such as optimizing for one product selection or one supplier at a time, and then “locking” the completed selection. After locking the selection, the buyer may perform a new optimization to optimize the remaining, unselected options. The buyer may proceed through multiple iterations of this process until all selections have been completed.

FIG. 22 depicts a screen capture of a product selection interface 2200 in accordance with some example embodiments. The product selection interface 2200 allows for a buyer to select one or more products that correspond to a particular need of the buyer. For example, one or more products may be identified from the buyer's previous spending in the category associated with the RFP, and, based on the responses received from suppliers, the buyer may have several selections to choose from to meet their need for the particular products identified based on their previous purchases in the product category. These products may be identified as cross-references by the supplier in response to the RFP, or the products may be identified as cross-references via other methods as described above. The buyer may thus decide how their spending should be allocated across the products they are offered. As described above, the buyer may be presented with an initial set of product selections and spending allocations which may then be modified, or the buyer may make manual selections without an initial allocation.

The interface 2200 shows a set of products and cross-references that relate to a product currently being purchased by the buyer. The cross-reference products may be provided by the suppliers (e.g., the supplier may indicate in an RFP response which of the supplier's products are valid cross-references for a product in the RFP), by the market platform (e.g., the market platform may analyze buyer spending data or buyer purchase planning selections to determine which products are most frequently selected as cross-references), or by other users (e.g., other users may indicate that they use a particular product as a cross-reference for a first product). The interface 2200 may allow the buyer to allocate their spending across these various products, or to select a particular product they wish to purchase for this cross-reference. As described above, the buyer may choose to allocate greater than or less than 100% of their spending for a particular set of products if the buyer anticipates an increased or decreased demand as compared to previous measurement periods. The interface 2200 may also display the price of each product and a discount level for a particular pricing tier offered by the supplier of the product. The interface 2200 may allow the buyer to select a particular product to obtain additional data about the product. For example, selecting one of the cross-references may take the buyer to an information page about the product. The interface 2200 may thus allow for allocations to be made to the purchase plan at an individual product level, although alternative embodiments may be implemented where allocations are made at a product category level, or as a set of product categories.

FIG. 23 depicts a flow diagram of an example method 2300 for generating a purchase plan in accordance with some example embodiments. As described above, a buyer may receive a set of pricing proposals in response to an RFP. A market platform may provide a framework or utility for analysis of these pricing proposals to determine which proposals the buyer should select to optimize their spending and maximize value. As described above, optimization may include minimizing overall costs, minimizing costs for a particular supplier, minimizing a change from current spending patterns, minimizing the number of suppliers, maintaining relationships with current suppliers, selecting a highest-rated selection of products, or any other method of selecting particular proposals, products, and performance levels for buyer spending. The method 2300 describes a process by which a buyer may generate a purchase plan that provides the buyer with a guide for which products to select and how to allocate their spending in order to reach the optimized spending determined by the buyers purchasing preferences. The method 2300 may be linked to spending for a particular RFP. In other words, the generated purchase plan may correspond to a particular product, set of products, product category, or the like requested by the user, for which the user has received responses from one or more suppliers. Although the method 2300 is generally discussed with respect to specific pricing proposals received from suppliers, alternative embodiments may allow the user to estimate or preview pricing proposals. For example, the market platform may provide the user with data for typical pricing proposals received in a category before the user even generates the RFP, so that the user may input test data to determine if a RFP is worthwhile (e.g., whether suppliers for the products sought are offering enough of a discount to justify an RFP).

At action 2302, previous product selections may be determined from the buyer's previous spend history. The initial product selection may correspond to products previously purchased by the buyer within the category identified by the RFP submitted by the buyer. For example, the initial product allocations may be representative of previous buyer product purchases in the category, at previous spending allocations. In the present example, buyer spend data, such as the buyer spend data 1506 described with respect to FIG. 15, is used to determine the previous product selections. However, alternative data could also be used to derive the initial allocations. For example, for a new buyer with no existing spend history, initial goals or product selections, might be determined using spend data from other buyers with similar characteristics, buyers from affiliated organizations, buyers of a similar number of employees, market shares of leading suppliers in a category, buyers with a similar number of facilities, buyers of a similar practice type (e.g., cardiologists, surgeons, emergency rooms), or by various other factors.

At action 2304, a set of available products are determined As described above with respect to FIG. 15, in some circumstances buyers may not be able to select products that exactly conform to their previous purchasing habits. For example, products may be discontinued by suppliers, suppliers may go out of business, the supplier may not have responded to the buyer's RFP, or products may be out of stock. The method 2300 may thus determine which products to display to the buyer as initial allocations based on products that are indicated as available either in seller pricing proposals (e.g., RFP responses), or using a list of product cross-references. For example, if a buyer previously purchased a product that has since been discontinued, the method 2300 may examine the list of cross-reference items offered by sellers that responded to the RFP, and allocate spending to those cross-reference items. The products previously purchased by the user may be presented in a disabled or “grayed out” format, displaying to the buyer that the product they previously purchased is no longer available, while also presenting alternatives to the buyer to meet the need previously filled by the unavailable product. Alternatively, if a buyer desires a product that is provided by a seller that did not respond to the RFP, spending may be allocated to a cross-reference product offered by a seller that did respond. In some embodiments, the seller pricing proposals may include suggested product cross-references which may have initial spending allocated as appropriate. In additional or alternative embodiments, the interface may provide an icon indicating that a previously purchased product is unavailable, and prompt the user to select a cross-reference item. The initial list of products may include all products purchased by the buyer in a particular time period (e.g., the last 12 months), and spending may be allocated to those products according to the market share derived from the buyer's spend history. Spending allocations for particular products may be solely designated for previously purchased products, or they may be apportioned across product cross-references.

At action 2306, the product selections and spending allocations are presented to the buyer as a set of initial allocations to provide the buyer with a starting point for creating their purchase plan. As described above with respect to FIGS. 15-22, the initial allocations may be determined according to a variety of methods and optimization algorithms, or they may be manually provided by the buyer.

At action 2308, an update to product selection, optimization criteria, or product purchase allocations may be received. As described above, the buyer may be presented with the ability to alter the initial allocations to see the impact that the modifications will have on their overall spending. As such, the buyer may select alternative cross-reference products, adjust contract durations, adjust sales volume or product spending allocation levels, select different suppliers, select alternative optimization methods, or the like.

In some embodiments, manual modifications and updates may cause alterations in other sections of the interface. For example, adjustment of a product selection may alter target market share goals for the each supplier in that category, representing the effect of buying that particular product at that particular price from that particular supplier, rather than from another supplier. Adjustment to product selections or contract performance levels (e.g., market share commitments) may change the active discount level for one or more sellers. This may cause an update in the prices associated with the previous allocations.

Selection of an alternative product may thus result in recalculation of market share for each supplier, recalculation of an overall projected savings, recalculation of projected spend with the supplier, recalculation of the product pricing tier, and recalculation of product prices for previously allocated products in the event the product pricing tier changes.

Alternatively, the buyer may choose to select certain goals prior to generating the purchase plan. These goals may include goals for contract duration, price discount levels, supplier market shares, overall percentage savings, minimization of conversion costs, or the like. The buyer may specify these goals and be presented with a set of initial allocations that meet those goals, or the buyer may arrive at initial values via any other method as described above. These goals may inform various other characteristics of the purchase plan. For example, the buyer may choose to set a particular supplier at a particular market share level, and have pricing displayed by the purchase plan utility reflect that market share level. Upon completion of any changes made to the purchase plan by the buyer, the purchase plan may notify the buyer if the previously defined goals were met based on the product selections and spending allocations chosen by the buyer. For example, if the buyer chooses a market share goal for a particular supplier and receives pricing based on that market share, but then selects products and spending allocations that will not reach the market share goal, then the pricing utility may notify the buyer that the selected purchase plan does not meet the specified goals. The purchase plan may make suggestions to the buyer to assist the buyer with selections that will meet those goals. Alternatively, the system may notify the buyer that they are eligible for higher discounts (e.g., if the buyer's selections reach a higher discount tier for a particular supplier), and thus the buyer may be entitled to an additional discount. In this manner, the system may provide feedback either dynamically as modifications are made to the purchase plan or upon a request by the buyer to recalculate the values based on new product selections and spending allocations.

At action 2310, adjustments are made to the interface based on the modifications performed at action 2308. In this manner, the buyer may be presented with a real-time view of the impact of these changes on their planned spending.

At action 2312, the adjustments are presented to the buyer, and at action 2314 the buyer may be prompted to determine if the user has completed the purchase planning process. For example, the buyer may request that the purchase planning utility generate a set of committed pricing agreements based on the product selections and spending allocations displayed in the interface, or the buyer may use a “confirm purchase plan” interface control to indicate acceptance of the purchase plan. If the buyer indicates that purchase planning has been completed, the method proceeds to action 2316. Otherwise, the method returns to action 2308 to receive further adjustments to the product selections, allocations, and/or optimization criteria.

At action 2316, the purchase plan may be generated and stored for use as a set of ongoing metrics to track spending by the buyer. Generation of the purchase plan may also cause generation of one or more committed pricing agreements for execution by the buyer and seller. The terms of the committed pricing agreements may conform to the terms selected by the buyer during generation of the purchase plan. For example, if the product selections and spending allocations for a buyer result in a 50% market share for a certain supplier in the purchase plan, the committed pricing agreement may be generated with terms requiring a 50% market share commitment, and if the supplier offers a particular discount at 50% market share, that discount will likewise be memorialized in the committed pricing agreement. As described above, purchase plans may be associated with a particular category, or each purchase plan may be associated with a separate RFP, resulting in the potential for multiple purchase plans in the category, though typically each supplier may only have one active contract for a particular product, set of products, or product category, depending upon the implementation of the process. Purchase plans may persist across the category, such that product selections and spending allocations made in a first purchase plan are reflected in other purchase plans for the category.

At action 2318, buyer spending may be monitored using the purchase plan as a metric. For example, buyer spending may be tracked against the commitment levels specified in the purchase planner so that the buyer may be made aware as to whether they are conforming to their purchase plan. Ongoing measurement in this manner may provide the buyer with the ability to adjust their spending to conform to the plan in advance of compliance measurement periods, to ensure that they are on track to meet their planned spending levels.

FIG. 24 depicts a flow diagram of an example method 2400 for providing product selection analytics in accordance with some example embodiments. As described above, the market platform server 202 may gather data from transactions performed by buyers and sellers. The method 2400 is an example of a method that may be performed by the market platform server 202 or any apparatus configured similarly to the apparatus 102 for the purpose of providing product selection analytics. The captured data may be analyzed and used to derive a set of product cross-references to assist buyers and suppliers with selection of products during, for example, a purchase planning operation. The method 2400 may function to identify products that may function as valid cross-references for product selections offered to a supplier. The method 2400 may further mark one or more of these cross-references as a “community”, or “crowd-sourced” cross-reference. In some embodiments, cross-references identified by this method may be further identified as “crowd sourced” cross-references, by virtue of the fact that data derived from aggregated transaction data. In some embodiments, the crowd-sourced cross-references may be derived and/or filtered based on particular buyer characteristics, such as by examining transactions performed by buyers with a similar size, spending volume, or other common characteristics with the buyer performing the particular product selection for which cross-references are being identified. Although the instant example relates to identification of cross-references using captured data, it should be readily appreciated that other data could be derived from data captured by the market platform. For example, contract parameter data may be captured to provide analytics related to frequently selected contract parameters to assist buyers and suppliers with contracting. This contract data may include data about contract durations, market share commitment levels, sales volume discounts, and the like. The market platform may observe both preference data (e.g., indications by buyers and suppliers as to which parameters they would prefer when generating or responding to an RFP) and actual performance data (e.g., what contract parameters are most frequently associated with contracts that are actually executed). In some embodiments, providing such analytic data to buyers and suppliers during the contracting process may result in buyers and suppliers gravitating towards preferences that result in an overall best value for both parties, thus simplifying the contracting process since both parties are more likely to begin with a position that is agreeable to both sides.

At action 2402, the method 2400 functions to capture product cross-reference data. The product cross-reference data may include data from a variety of sources. Data captured from some examples of these sources is represented by sub-actions 2404, 2406, 2408, and 2410. These sub-actions are intended to describe examples of types of data that may be captured by the market platform to derive analytics that may be used to identify product cross-references, but these examples are not intended to be an exhaustive list. It should be readily appreciated that additional or alternative metrics and data not listed herein may be gathered for the purpose of identifying products to a buyer for selection in a purchasing operation. Furthermore, these sub-actions may be employed in various combinations, and in some embodiments some or all of these sub-actions may be omitted entirely.

At sub-action 2404, data may be captured from buyer purchase planning decisions. As described above with respect to FIGS. 14-24, buyers may be presented with a plurality of products and suppliers during a purchase planning operation. For example, as buyers allocate spending to products during the purchase planning operation, the market platform may note which products are selected from among the product selections offered by the suppliers. In some embodiments, product selections may be stored along with information indicating which products the selected products were selected in lieu of Additionally or alternatively products may be ranked objectively, such as by indicating the number of times a particular product was selected overall, or a ratio of how often the product is selected when presented as an option in a purchase planning operation.

At sub-action 2406, buyer purchase data may be captured. In addition to capturing buyer purchase plan decisions as described with respect to sub-action 2404, actual buyer spending may be captured by observing buyer purchase orders and invoices. This data may be useful in addition to the buyer purchase planner selections because buyers may not always strictly adhere to their purchase planner selections for a variety of reasons. The buyer purchase data may also be examined in view of the purchase plan generated by the buyer. For example, the fact that a buyer selected a product in a purchase plan is one observed behavior, but the buyer is not necessarily bound to this decision. The fact that a buyer did or did not actually purchase the selected product may be more probative as to whether the product is a good cross-reference selection than the presence within the purchase plan. In some embodiments, buyer data, such as the size of the buyer, whether the buyer is part of a larger organization, whether the buyer is for-profit or not-for-profit, and the like, is captured along with purchase data to assist with later analysis and filtering operations. At sub-action 2408, buyer product selections performed in response to supplier events may be captured. Supplier events may include, but are not limited to, product recalls, discontinuation of products, back order of products, replacement of products, or the like. In some embodiments, the market platform may be aware of when these supplier events occur (e.g., the market platform may provide a capability allowing a supplier to initiate a product recall of a particular product via a supplier interface), and may observe purchasing decisions that occur in response to one of these events. For example, in the event of a product recall, a buyer may be required to select an alternative product to meet their needs while the recall is ongoing. The buyer may thus select a new product instead of the recalled product, and the market platform may identify that the new product selection has occurred and the buyer is no longer purchasing the recalled product. Similarly, the market platform may detect changes in purchasing habits when suppliers discontinue a product or a product is on back-order. Additionally, when discontinuing a product, suppliers may identify a different product as a cross-reference for the discontinued product. In some embodiments, the market platform may allow the replacement product to inherit any identified cross-references for the discontinued product. Alternatively, the market platform may force the replacement product to achieve status as a cross-reference on its own merits, or a hybrid approach may be employed where the replacement product does not obtain status as a cross-reference unless a certain proportion of buyers allocate spending to the replacement product upon the discontinuation of the discontinued product. In some embodiments, the seller suggested cross-references may be included as part of the observed behaviors. For example, the fact that a seller made a suggestion for a product cross-reference to an incumbent product could be accorded some weight, but the fact that a buyer selects the seller suggested cross reference in purchase planning may be accorded much greater weight.

At sub-action 2410, supplier actions may be observed to identify cross-references. For example, if a first supplier recommends their product “A” as a seller suggested cross-reference to a second supplier's product “B”, and the second supplier recommends the first supplier's product “A” as a cross-reference to their product “B”, then this behavior may be indicative of a general agreement that products “A” and “B” are valid cross-references.

The sub-actions 2404, 2406, 2408, 2410 may collectively gather together various data relating to product cross-reference selections. This data may be parsed and analyzed by the market platform to suggest cross-references that represent the overall views of the market community (e.g., products that are generally accepted by the market as cross-references to one another). In calculating these “crowd-sourced” cross-references, different data may be given different weight in the calculations. For example, data provided directly by suppliers may be given less weight, as suppliers have a financial incentive to list their products as valid cross-references to as many other products as possible, while actual purchase data from buyers may be weighted more heavily. As more and more purchases and product selections occur, the volume of data available to the market platform may improve, resulting in better cross-reference suggestions. In some embodiments, the market platform may employ a machine learning algorithm that tracks whether suggested crowd-sourced cross-references are selected by users during purchasing decisions. The machine learning algorithm may monitor whether buyers selected the cross-reference, and improve the cross-reference matching algorithm based on whether the suggested cross-reference was selected. The weight afforded to different factors for selecting cross-references may thus be determined dynamically based on how the previous cross-reference selections were received by users.

In some embodiments, data captured at later phases may be used to alter the weight of data captured at a previous phase. For example, a cross-reference decision made at the purchase planning phase (sub-action 2404), may have its corresponding weight lowered if the buyer does not actually spend according to the purchase plan (as observed at sub-action 2406). Furthermore, cross-reference decisions that represent larger market share, volume, or larger allocation shifts may be accorded a higher weight than smaller market share, volume, or allocation shifts. Newer product selection decisions may also be accorded more weight than older product selection decisions.

At action 2412, a set of products may be determined. The set of products may be determined in response to a purchase planning operation entered into by a user, or, in some embodiments, the set of products may be the buyer's current spending in a particular product category. For example, the user may initiate a RFP and be presented with a set of products to which to allocate product spending. Alternatively, the set of products may be all products available in a particular group of products. The set of products may determine how cross-references are selected. For example, if a buyer is not presented with the opportunity to purchase a particular product during a purchase planning operation, it may not be helpful to identify that particular product of the buyer as a preferred cross-reference. However, in some embodiments such a product may be presented to the user, to indicate to the user an alternative not offered by any of the suppliers who have responded to the RFP (and thus perhaps provide an indication to the user that they should wait for additional responses before entering into a contract). In some embodiments, cross-references for each product may be maintained in a cross-reference database. For example, each product offered by the market platform may have one or more “community” cross-references that are presented to buyers during purchase planning operations. In some embodiments, cross-references may not even be offered for purchase through the contracting system offered by the purchase planner. For example, the market platform may gather data for transactions that are not associated with the contract process described herein, but still processed by the market platform (e.g., the market platform may operate to process buyer invoices and supplier shipments, but not the actual contracting process). These cross-references may still be identified to buyers, even if they are not available for the contracting process, such as because the supplier of the cross-references does not participate in contracting on the market platform. In some embodiments, community cross-references are objective cross-references in that, each product is identified as having one or more community cross-reference products, whether or not said community cross-reference products are available. In some embodiments, community cross-references may be determined dynamically based on products available to a particular buyer (e.g., in response to a particular RFP) or during a particular purchase planning operation, such that a community cross-reference is identified from products available to the buyer for that particular operation.

At action 2414, cross-references are determined based on the set of products and the data collected at action 2402. For example, the market platform may calculate and create a rank order for each possible cross-reference observed in the market, and the top ranked cross-reference for each product of the set of products may be presented to the buyer.

Cross-references may be segmented in different manners. Cross-reference decisions may be configurable by a buyer, as different buyers may have different priorities. For example, a buyer may be more interested in cross-references derived from data provided by other buyers with a similar size, spend volume, or geographical location, a buyer may be only interested in cross-references for products that are lower cost than their current allocations, or a buyer may be interested in cross-reference products offered by a particular supplier. A buyer interface may provide configuration options allowing the buyer to adjust how the cross-references are determined based on the options enumerated above, or various other implementations for determining how the cross-references are identified. Product cross-references may be presented to the buyer via an interface, such as the purchase planner interfaces described with respect to FIGS. 19-22. One or more cross-references identified by the method 2400 may be marked or otherwise highlighted in the interface to indicate that the cross-reference is a “crowd-sourced”, or “community” cross-reference. In some embodiments, the buyer may be presented with further data indicating which features of the cross-reference have enabled it to earn the status as a “crowd-sourced”, or “community” cross-reference. For example, the interface may place a cursor, marker, or highlight on a particular product to notify the buyer that the particular product is most frequently selected by other buyers with similar characteristics.

In some cases, cross-references may decay over time, or otherwise be indicated as no longer valid. For example, if buyers are no longer frequently selecting a particular product, then it may have identification as a community cross-reference removed from the market platform cross-reference database. In some embodiments, cross-reference relationships decay over time to facilitate removal of outdated cross references and to ensure that cross-references suggested by the market platform remain relevant. In some embodiments, the rate at which a particular cross-reference decays may be associated with certain factors, such as the sales volume of the product (e.g., products with a low sales volume may not decay as fast as products with higher turnover). In some embodiments, cross-references may be determined or re-determined in response to particular events. For example, a new cross-reference may be determined for a product if the current cross-reference is discontinued or otherwise unavailable. Determination of such an alternative product may also generate a notification to buyers of the discontinued product, informing them of the alternative cross-reference. In some embodiments, buyers of the previous cross-reference may automatically have spending for the previous cross-reference allocated to the new cross-reference in the purchase planning operation.

FIG. 25 depicts a flow diagram of an example method 2500 for generating a contract opportunity map in accordance with some example embodiments. Buyers may have a difficult time identifying an optimal use of their resources when engaging in contract negotiations to satisfy their purchasing needs. Some RFPs may prove more time consuming than others due to delays in the receipt of responses from suppliers, and some products may offer such little margin to suppliers that discounts are low or nonexistent. A contract opportunity map may provide a visual representation of the complexity and value offered by contracting for purchase of a particular product, set of products, or product category, and thus provide buyers with valuable information to assist with allocation of their contracting resources.

At action 2502, a complexity may be determined for establishing a contract for a particular product, set of products, or product category. In some embodiments, the complexity may be a subjective measure provided directly by the buyer. For example, the buyer may drag and place an icon along a complexity spectrum, with easier contracts associated with a first end of the spectrum and more difficult contracts associated with the opposite end. The placement of this icon may translate to a data value used to calculate the contract complexity. Alternatively, complexity may be derived based on data captured for the product, set of products, or product category. For example, a complexity value may be derived based on the elapsed length of time from when the buyer initiates the RFP to when the buyer enters a pricing agreement with a supplier. Additionally or alternatively, the complexity value may be associated with a number of products in a category (e.g., purchase decisions for a category with more products may be more complex to plan than for a category with fewer products), an ease of conversion (e.g., a cost associated with transitioning to a new supplier), a number of suppliers in a category (e.g., categories with fewer suppliers may tend to be less complex than categories with more suppliers), or certain attributes of the products (e.g., fungible or commodity products may be easier to contract for, due to the ease of performing “apples to apples” comparisons). In some embodiments, a complexity value is determined based on a calculation employing a weighted series of one or more of these values. For example, a degree of difficulty for a particular product or category may be inferred from observing the frequency of contracts generated on for the particular product or category using the platform. For example, more contracts in a category could mean that the category is easier in which to contract, or that the category has a high value (e.g. a high savings potential). In some embodiments, manually entered user data for contract complexity or value may be compared with data gathered by the market platform. For example, as described above, user values may be weighted according to the user's experience with the market platform, or according to the particular contracts in which the user has entered. As a particular example, if a user only has experience with categories that are considered very difficult by the market platform, an indication from the user that a particular contract was less difficult may be accorded less weight, since the user may not have experience with a range of contracts to truly know what an “easy” contract may be like.

At action 2504, a benefit of contracting for the particular product, set of products, or category is determined. The benefit may be associated with a value that a buyer may derive if they are able to successfully negotiate a purchase agreement for the identified product, set of products, or category. As described with respect to action 2502, the benefit may be manually entered by the buyer using an interface to place a marker along a spectrum related to the buyer's perceived benefit. Alternatively, the benefit may be derived based on data gathered about transactions performed for the product, set of products, or category. For example, the benefit may be related to an average savings obtained by buyers when contracting, an average discount level obtained by buyers when contracting, a likely savings derived by the particular buyer (e.g., by identifying categories in which the buyer has the greatest amount of spend and that offer significant discounts as having a greater benefit for the buyer), or the like.

At action 2506, a marker associated with the particular product, set of products, or category is placed on in interface according to the complexity and benefit derived at actions 2502 and 2504. An example of an interface as created by the method 2500 is described below with respect to FIGS. 26 and 27.

FIG. 26 depicts an illustration of an example of a contract opportunity map 2600 in accordance with some example embodiments. The contract opportunity map 2600 depicts a series of product purchase categories in which a buyer may wish to contract. In the present example, each product purchase category is denoted by a marker, such as the marker 2602. The markers are placed along a complexity axis 2604 (here represented as an “ease of conversion” metric), and a benefit axis 2606 (here represented as a “savings potential” metric). Although the instant example of a complexity axis 2604 is presented with respect to an “ease of conversion” axis, various additional or alternative metrics could also be applied to determine the complexity of the category. For example, the complexity axis 2604 could refer to an “ease of contracting” metric derived from user feedback, frequency within which the category is contracted, the average length of time between an RFP and execution of a contract responsive to that RFP in the category, or according to various other parameters. Additionally or alternatively, any other metric related to the complexity of contracting in the category could be used for the complexity axis 2604. The location of markers along these axes indicates how the particular purchase category is perceived by the community and/or market platform as far as the complexity to contract and potential benefit for contracting in the category. In some embodiments, the contract opportunity map 2600 may be configurable by the buyer, such that the buyer can adjust how the values are calculated for each axis, and from what data the values are derived (e.g., from data related to the particular buyer, for all similar buyers, or for all buyers). The contract opportunity map 2600 may provide the ability for the buyer to select a particular marker and see additional information about that marker, such as the metrics used to derive the data for that marker. In some embodiments, selection of a marker may take the buyer to a page allowing the buyer to view their spend in that category along with an interface allowing the buyer to initiate an RFP in the category. In this manner, the placement of each marker may provide information to assist the buyer as to how to allocate their contracting resources. For example, markers associated with the upper right corner of the interface may be associated with low complexity and a high benefit. As such, the buyer may wish to concentrate their resources on these contracts. Contracts in the lower left quadrant may be associated with a low benefit and high complexity, and as such represent a less efficient use of the buyer's time.

FIG. 27 depicts an illustration of an example of detail view of a contract opportunity map 2700 in accordance with some example embodiments. The contract opportunity map 2700 may be similar in form and construction to the contract opportunity map 2600 described with respect to FIG. 26. In the present example, a buyer has selected a particular marker, and in response been provided with a detailed view 2702 of data associated with the category for the selected marker. The detailed view 2702 may display the potential savings for the buyer, a representation of the complexity of contracting in the particular category, or various other data.

It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory 104 of an apparatus employing an embodiment of the present invention and executed by a processor 102 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
capturing a set of transaction data, the transaction data comprising a selection of at least one product selected from a plurality of products, the selection performed by a first buyer during a first transaction;
determining, using a processor, that an alternative product is a valid cross-reference for the at least one product using the transaction data; and
providing an indicator during a subsequent transaction for the at least one product that the at least one alternative product is a valid cross-reference for the at least one product.

2. The method of claim 1, wherein the alternative product is determined as a valid cross-reference in response to determining that the first buyer selected the alternative product when presented with an option to select one or more of the alternative product and the first product.

3. The method of claim 1, wherein the indication marks the alternative product as a community-derived cross-reference.

4. The method of claim 1, further comprising:
capturing a plurality of types of transaction data; and
assigning a different weight to each type of transaction data based on the type of transaction data.

5. The method of claim 4, wherein the types of transaction data comprise at least one of buyer spend data, product selections that occur in response to supplier events, product selections performed by a buyer during a purchase planning operation, or product information provided by suppliers.

6. The method of claim 5, wherein transaction data comprising product information provided by suppliers is accorded a different weight in determining that the alternative product is a cross-reference than transaction data comprising buyer spend data.

7. The method of claim 1, further comprising determining if the at least one product has been backordered, recalled, or discontinued.

8. An apparatus comprising at least one processor configured to:
capture a set of transaction data, the transaction data comprising a selection of at least one product selected from a plurality of products, the selection performed by a first buyer during a first transaction;
determine that an alternative product is a valid cross-reference for the at least one product using the transaction data; and
provide an indicator during a subsequent transaction for the at least one product that the at least one alternative product is a valid cross-reference for the at least one product.

9. The apparatus of claim 8, wherein the alternative product is determined as a valid cross-reference in response to determining that the first buyer selected the alternative product when presented with an option to select one or more of the alternative product and the first product.

10. The apparatus of claim 8, wherein the indication marks the alternative product as a community-derived cross-reference.

11. The apparatus of claim 8, wherein the processor is further configured to:
capture a plurality of types of transaction data; and
assign a different weight to each type of transaction data based on the type of transaction data.

12. The apparatus of claim 11, wherein the types of transaction data comprise at least one of buyer spend data, product selections that occur in response to supplier events, product selections performed by a buyer during a purchase planning operation, or product information provided by suppliers.

13. The apparatus of claim 12, wherein transaction data comprising product information provided by suppliers is accorded a different weight in determining that the alternative product is a cross-reference than transaction data comprising buyer spend data.

14. The apparatus of claim 8, wherein the processor is further configured to determine if the at least one product has been backordered, recalled, or discontinued.

15. A computer readable storage medium comprising instructions that, when executed by a processor, configure the processor to:
capture a set of transaction data, the transaction data comprising a selection of at least one product selected from a plurality of products, the selection performed by a first buyer during a first transaction;
determine that an alternative product is a valid cross-reference for the at least one product using the transaction data; and
provide an indicator during a subsequent transaction for the at least one product that the at least one alternative product is a valid cross-reference for the at least one product.

16. The computer readable storage medium of claim 15, wherein the alternative product is determined as a valid cross-reference in response to determining that the first buyer selected the alternative product when presented with an option to select one or more of the alternative product and the first product.

17. The computer readable storage medium of claim 15, wherein the indication marks the alternative product as a community-derived cross-reference.

18. The computer readable storage medium of claim 15, further comprising instructions that configure the processor to:
capture a plurality of types of transaction data; and
assign a different weight to each type of transaction data based on the type of transaction data.

19. The computer readable storage medium of claim 18, wherein the types of transaction data comprise at least one of buyer spend data, product selections that occur in response to supplier events, product selections performed by a buyer during a purchase planning operation, or product information provided by suppliers.

20. The computer readable storage medium of claim 19, wherein transaction data comprising product information provided by suppliers is accorded a different weight in determining that the alternative product is a cross-reference than transaction data comprising buyer spend data.
